(19) United States
(12) Patent Application Publication
(10) Pub. No.: US 2013/0212070 A1
(43) Pub. Date: Aug. 15, 2013

(54) MANAGEMENT APPARATUS AND MANAGEMENT METHOD FOR HIERARCHICAL STORAGE SYSTEM

(71) Applicants: Nobuyuki Saika, Yokosuka (JP); Homare Kanie, Yokohama (JP); Hitoshi Arai, Chigasaki (JP); Atsushi Murakami, Yokohama (JP); Hirofumi Ikawa, Odawara (JP)

(72) Inventors: Nobuyuki Saika, Yokosuka (JP); Homare Kanie, Yokohama (JP); Hitoshi Arai, Chigasaki (JP); Atsushi Murakami, Yokohama (JP); Hirofumi Ikawa, Odawara (JP)

(73) Assignee: HITACHI, LTD., Chiyoda-ku, Tokyo (JP)

(21) Appl. No.: 13/393,980

(22) PCT Filed: Feb. 13, 2012
(86) PCT No.: PCT/JP2012/000944

§ 371 Date: Mar. 2, 2012

(51) Int. Cl. G06F 7/00

(52) U.S. Cl. 707/654; 707/E17.01; 707/E17.005

(57) ABSTRACT

The present invention enhances user usability by storing more files close to the user. A replication processing part 3A creates a replica of a prescribed file, which is in a first file management apparatus, in a second file management apparatus. A single instance processing part 3B selects as a duplicate data removal target another prescribed file in the first file management apparatus in accordance with a first prescribed condition, and converts the selected other prescribed file to a reference-source file, which references data of a prescribed reference file. A stubification processing part 3C selects a stubification candidate file, which constitutes a target of a stubification process, in accordance with a second prescribed condition, and executes stubification processing with respect to the stubification candidate file in accordance with a third prescribed condition.

### TECHNICAL FIELD

The present invention relates to a management apparatus and a management method for a hierarchical storage system.

### BACKGROUND ART

A hierarchical storage system for moving files between a file server installed on the user side and a file server installed on the data center side has been proposed (Patent Literature 1). In this hierarchical storage system, a file, which the user uses frequently, is stored in the user-side file server, and a file, which the user uses infrequently, is stored in the data center-side file server.

### CITATION LIST

### Patent Literature

[PTL 1]
Japanese Patent Application Laid-open No. 2011-76294

### SUMMARY OF INVENTION

### Technical Problem

In the case of the prior art, since a file that the user uses infrequently is moved to the data center-side file server, when the user tries to access this file, access takes a long time. This is because the user-side file server must acquire the access-target file from the data center-side file server by way of a communication network such as a WAN (Wide Area Network). Therefore, in comparison to a file stored in the user-side file server, response performance drops greatly and user usability also declines when a file is stored on the data center-side file server.

With the foregoing in mind, an object of the present invention is to provide a management apparatus and a management method of a hierarchical storage system, which make it possible to effectively use a storage area of a first file management apparatus accessible from a user terminal to store as many files as possible. Another object of the present invention is to provide a management apparatus and a management method for a hierarchical storage system, which make it possible to effectively use a storage area of a first file management apparatus and a storage area of a second file management apparatus.

### Solution to Problem

A hierarchical storage system management apparatus related to one aspect of the present invention is a management apparatus for managing a hierarchical storage system, which hierarchically manages a file by a first file management apparatus and a second file management apparatus, comprising a replication processing part, which creates a replica of a prescribed file, which is in a first file management apparatus, in a second file management apparatus, a duplicate removal processing part, which removes duplicate data by selecting, in accordance with a preconfigured first prescribed condition, another prescribed file in the first file management apparatus as a duplicate data removal target and converting the selected other prescribed file to a reference-source file for referencing data in a prescribed reference file, and a stubification processing part, which selects, in accordance with a preconfigured second prescribed condition, a stubification candidate file, which becomes the target of a stubification process for deleting data of the prescribed file in the first file management apparatus, and, in addition, leaving data only in the replica of the prescribed file created in the second file management apparatus, and also stubifying the stubification candidate file in accordance with a preconfigured third prescribed condition.

A hierarchical storage system management apparatus related to one aspect of the present invention may also comprise a file access receiving part for creating a replica of a copy-source file as a reference-source file in a case where the creation of a copy-source file replication inside the first file management apparatus has been requested.

The first file management apparatus may be comprised as a file management apparatus capable of being directly accessed from a user terminal, and the second file management apparatus may be comprised as a file management apparatus not capable of being directly accessed from a user terminal.

The configuration may also be such that a prescribed reference file stores the number of references denoting the number of reference-source files, which have the prescribed reference file as a reference, and each time a reference-source file is deleted or each time a stubification process is carried out with respect to a reference-source file, the number of references is decremented, and when the number of references becomes 0, the file access receiving part is able to delete the prescribed reference file.

The present invention can also be understood as a computer program for controlling a hierarchical storage system management apparatus.

### BRIEF DESCRIPTION OF DRAWINGS

FIG. 1 is an illustration showing an overview of an entire embodiment.

FIG. 2 is a hardware block diagram of a hierarchical storage system.

FIG. 3 is a software block diagram of a hierarchical storage system.

FIG. 4 is an illustration showing a relationship between a file system and an inode management table.

FIG. 5 is an illustration showing the inode management table in detail.

FIG. 6 is an illustration showing an extension part of the inode management table.

FIG. 7 is an illustration showing an overview of a replication process.

FIG. 8 is an illustration showing an overview of a single instance process.

FIG. 9 is an illustration showing a storage location of a clone-source file.

FIG. 10 is an illustration showing how a normal file is converted to a clone file.

FIG. 11 is an illustration showing how a clone file stores only difference data with respect to a clone-source file.

FIG. 12 is an illustration showing an example of a case in which a single instance has been applied to a so-called virtual desktop environment.

FIG. 13 is an illustration showing an example of a case in which a single instance is applied to document creation.

FIG. 14 is an illustration showing an example of a case in which a single instance is applied to database replication.

FIG. 15 is an illustration showing an overview of a stubification process.

FIG. 16 is an illustration showing a clone-source file managing a number of clone files from which it is referenced.

FIG. 17 is an illustration showing an overview of a read process.

FIG. 18 is an illustration showing an overview of a write process.

FIG. 19 is an illustration showing an overview of a copy process.

FIG. 20 is a flowchart respectively showing a read process and a write process carried out by the receiving program.

FIG. 21 is a continuation of the flowchart of FIG. 20.

FIG. 22 is a flowchart of a copy process carried out by the receiving program.

FIG. 23 is a flowchart of a delete process carried out by the receiving program.

FIG. 24 is a flowchart showing the overall operation of a data mover program.

FIG. 25 is a flowchart showing a stubification process carried out by the data mover program.

FIG. 26 is a flowchart showing a replication process carried out by the data mover program.

FIG. 27 is a flowchart showing a file synchronization process carried out by the data mover program.

FIG. 28 is a flowchart showing a process for selecting a duplicate file candidate.

FIG. 29 is a flowchart showing a process for detecting a duplicate.

FIG. 30 is a flowchart showing a process for removing a duplicate file.

FIG. 31 is an illustration showing a clone-source file and a clone file becoming the targets of a replication process (and a stubification process) related to a second example.

FIG. 32 is an illustration showing that a last access date/time of a clone-source file can be estimated on the basis of the last access date/time of a clone file.

FIG. 33 is flowchart showing a process for estimating the last access date/time of a clone-source file on the basis of the last access date/time of a clone file.

FIG. 34 is a flowchart for showing a read process and a write process carried out by the receiving program.

FIG. 35 is a continuation of the flowchart of FIG. 34.

FIG. 36 is another continuation of the flowchart of FIG. 34.

FIG. 37 is a flowchart showing a process for reading transfer data performed by the receiving program.

FIG. 38 is a flowchart of a copy process performed by the receiving program.

FIG. 39 is a flowchart showing a stubification process performed by the data mover program related to a third example.

### DESCRIPTION OF THE EMBODIMENT

An embodiment of the present invention will be explained below by referring to the attached drawings. However, it should be noted that the embodiment is merely an example for realizing the present invention, and does not limit the technical scope of the present invention. A multiple of characteristic features disclosed in the embodiment can be combined in a variety of ways.

In this description, information used in the embodiment is explained using the expression “aaa table”, but the present invention is not limited to this, and, for example, other expressions such as “aaa list”, “aaa database”, and “aaa queue” may be used. The information used in the embodiment may be called “aaa information” to show that this information is not dependent on the data structure.

When explaining the content of the information used in the embodiment, expressions such as “identification information”, “identifier”, “name” and “ID” may be used, but these expressions are interchangeable.

In addition, in explaining a processing operation of the embodiment, a “computer program” may be explained as the doer of the operation (the subject). The computer program is executed in accordance with a microprocessor. Therefore, the processor may also be read as the doer of the operation.

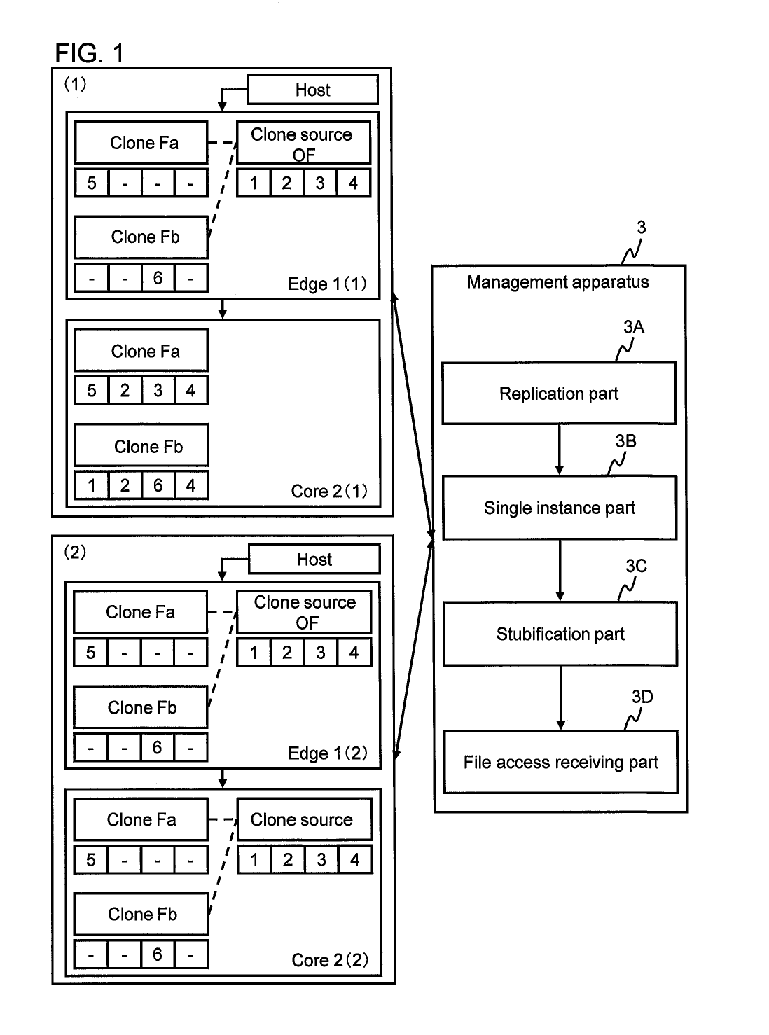

FIG. 1 is an illustration showing an overview of the embodiment as a whole. Two modes are shown in FIG. 1, i.e., one embodiment (1) shown in the upper left side, and another embodiment (2) shown in the lower left side of the drawing.

A hierarchical storage system of the embodiment hierarchically manages files using a first file management apparatus 1 disposed on an edge side, and a second file management apparatus 2 disposed on a core side. The edge side signifies the user site side. The core side is a side separated from the user site, and, for example, is equivalent to a data center.

A user can access the edge-side file management apparatus 1 via a host computer (abbreviated as host) serving as a “user terminal”, and may read/write from/to a desired file or create a new file. The host is not able to directly access a file in the core-side file management apparatus 2.

A file, which is used infrequently by the user, becomes the target of a single instance process as will be explained further below. In addition, a file with respect to which a prescribed period of time has elapsed since a last access date/time becomes a target of a stubification process, which will be explained further below. A replication process, which will be explained further below, is executed prior to performing the stubification process.

A management apparatus 3 is a computer for managing the hierarchical storage system, and, for example, may be disposed as a stand-alone computer separate from respective file sharing apparatuses 1 and 2, or may be disposed inside the edge-side file management apparatus 1.

The management apparatus 3, for example, comprises a replication processing part 3A, a single instance processing part 3B as a “duplicate removal processing part”, a stubification processing part 3C, and a file access receiving part 3D. “Processing part” is abbreviated as “part” in the drawing.

The replication processing part 3A is a function for creating a replica of a prescribed file, which is in the first file management apparatus 1, in the second file management apparatus 2.

The single instance processing part 3B detects and collectively manages duplicate files as a single file. The single instance process will be explained in detail further below, but a simple explanation will be given first. The single instance processing part 3B selects a file for which utilization frequency has decreased as a candidate file, and compares the candidate file with an existing clone-source file.

The clone-source file is equivalent to a “reference file”, and is a file, which constitutes a data reference destination. In a case where a candidate file and a clone-source file match, the single instance processing part 3B deletes the data of the candidate file, and configures the clone-source file as the reference destination of the candidate file. In accordance with this, the candidate file is converted to a clone file. The clone file is a file for referencing the data of the clone-source file as needed, and is equivalent to a “reference-source file”. This makes it possible to prevent the same data from being respectively stored in multiple files, and enables a storage area to be used efficiently. In the embodiment, it is possible to remove a duplicate in units of block data.

The stubification processing part 3C is a function for executing a stubification process. The stubification process will be explained in detail further below, but a brief explanation will be given first. First of all, it is assumed that the same file is respectively stored in the edge-side file management apparatus 1 and in the core-side file management apparatus 2 in accordance with the action of the replication processing part 3A.

When the free capacity of the edge-side file management apparatus 1 diminishes, the stubification processing part 3C selects a file in order from infrequently used files of a group of files stored in the edge-side file management apparatus 1 as a stubification target. The data of the file selected as the stubification target is deleted. A file comprising the same data as the stubified file exists in the core-side file management apparatus 2. Therefore, in a case where the host accesses the stubified file, data is read from the replicated file stored in the core-side file management apparatus 2 and transferred to the edge-side file management apparatus 1. The process for fetching the data of the stubified file is called a recall process in the embodiment.

The file access receiving part 3D receives a file access request from the host, and executes a prescribed process in accordance with the nature of the request. A file access request, for example, may be a read request, a write request, a copy request, or a delete request.

When a file copy is requested by the host, the file access receiving part 3D creates the requested file (the file derived by copying a copy-source file) as a clone file. Copying a certain file signifies that data is duplicated between a copy-source file and a copy file. Consequently, the embodiment, as will be explained further below, uses the single instance processing part 3B to convert the copy-source file to a clone file and to copy this clone file.

In embodiment (1) shown in the upper part of FIG. 1, a single instance process is executed in the edge-side file management apparatus 1, and one clone-source file and multiple clone files, which reference this clone-source file, are stored. The clone file in the edge-side file management apparatus 1 uses the clone-source file data, i.e., data, which duplicates the clone-source file constituting the reference, and stores data, which differs from that of the clone-source file (difference data). That is, the clone file only stores the difference data, which differs from the clone-source file.

Look at the core-side file management apparatus 2. Replicas of multiple files (replicated files), which are stored in the edge-side file management apparatus 1, are stored in the core-side file management apparatus 2. However, even when a file stored in the edge-side file management apparatus 1 is a clone file, a file comprising complete data the same as a normal file (specifically, a file comprising data, which duplicates that of a clone-source file, rather than only difference data) is created in the core-side file management apparatus 2, and is stored as a replica of the relevant clone file.

According to embodiment (1), numerous files can be stored in accordance with the edge-side file management apparatus 1 to enable the storage area of the edge-side file management apparatus 1 to be used effectively. Therefore, an access request from the host can be responded to quickly, enhancing user usability.

However, since a replica of the clone file is created, in a case where clone file data is transferred from the edge-side file management apparatus 1 to the core-side file management apparatus 2, both the clone file difference data and the clone-source file reference data must be transferred to the core-side file management apparatus 2.

In FIG. 1, two clone files Fa and Fb are shown. Four blocks of data, data “5”, “2”, “3” and “4”, are transferred from the edge-side file management apparatus 1 to the core-side file management apparatus 2 with respect to the one clone file Fa. Similarly, four blocks of data, data “1”, “2”, “6” and “4”, are transferred from the edge-side file management apparatus 1 to the core-side file management apparatus 2 with respect to the other clone file Fb.

Therefore, the transfer of duplicate data (in the example above, the transfer of data “2” and “4”) is carried out from the edge-side file management apparatus 1 to the core-side file management apparatus 2. For this reason, the transfer size the replication process is large, the transfer time is long, and the communication channel becomes congested. In addition, in a case where the duplicate removal process (single instance process) is not applied in the core-side file management apparatus 2, it is not possible to make efficient use of the storage area of the core-side file management apparatus 2. This is because the replica of the clone file is stored in the core-side file management apparatus 2 as a file comprising all its data the same as a normal file.

Consequently, it is conceivable that a replica of the clone-source file also be created in the core-side file management apparatus 2, and that the duplicate data of the clone-source file and the clone file be removed. That is, since a data transfer can be eliminated in a case where the configuration is such that clone-source file data and only the difference data of the clone file are transferred from the edge-side file management apparatus 1 to the core-side file management apparatus 2, the storage area of the core-side file management apparatus 2 can be efficiently utilized even in a case where a duplicate removal process (single instance process) is not applied in the core-side file management apparatus 2.

However, when a clone-source file replica is created in the core-side file management apparatus 2, the clone-source file also becomes a target of the stubification process. Because the clone-source file is a reference file, which is referenced from either one or multiple clone files, the clone-source file is managed such that direct user access is not possible.

Generally speaking, a file is targeted for a stubification process in order beginning from the oldest file, and as such, a clone-source file, which can not be accessed by the user, is more apt to become a stubification process target ahead of a user-accessible clone file.

When a clone-source file is stubified and data no longer remains in the edge-side file management apparatus 1, the responsiveness of all the clone files, which reference this clone-source file, worsens. This is because the data to be referenced must be acquired by the edge-side file management apparatus 1 from the core-side file management apparatus 2 by way of a WAN or the like. The responsiveness of the clone file improves for awhile following the completion of a recall process. However, when the clone-source file is finally stubified, the responsiveness of the clone file decreases once again.

Thus, even when a clone file, which references a clone-source file, is used frequently, the clone-source file, which provides data to this clone file, is determined to be used infrequently, and becomes the target of stubification.

Consequently, in embodiment (2) shown in the lower left part of FIG. 1, the utilization frequency of the clone-source file is evaluated appropriately, and a clone-source file stubification process is executed. In the embodiment (2), the index value for determining the propriety of stubifying a clone-source file is estimated on the basis of the index values of the respective clone files referencing this clone-source file. For example, in the embodiment (2), the last access date/time of the clone-source file is calculated as the average value of the last access dates/times of the respective clone files referencing this clone-source file.

According to the embodiment (2), since a single instantiated file can also be stored in the core-side file management apparatus 2, the storage area of the core-side file management apparatus 2 can be utilized effectively. In addition, because the clone-source file data and the stored difference data of the respective clone files may simply be sent from the edge-side file management apparatus 1 to the core-side file management apparatus 2, the size of the transfer data can be reduced, eliminating communication congestion.

In addition, since the clone-source file utilization frequency is evaluated appropriately, it is possible to inhibit the stubification of the clone-source file ahead of the clone file. As a result of this, the responsiveness of the clone file can be maintained, making it possible to prevent a drop in user usability.

### Example 1

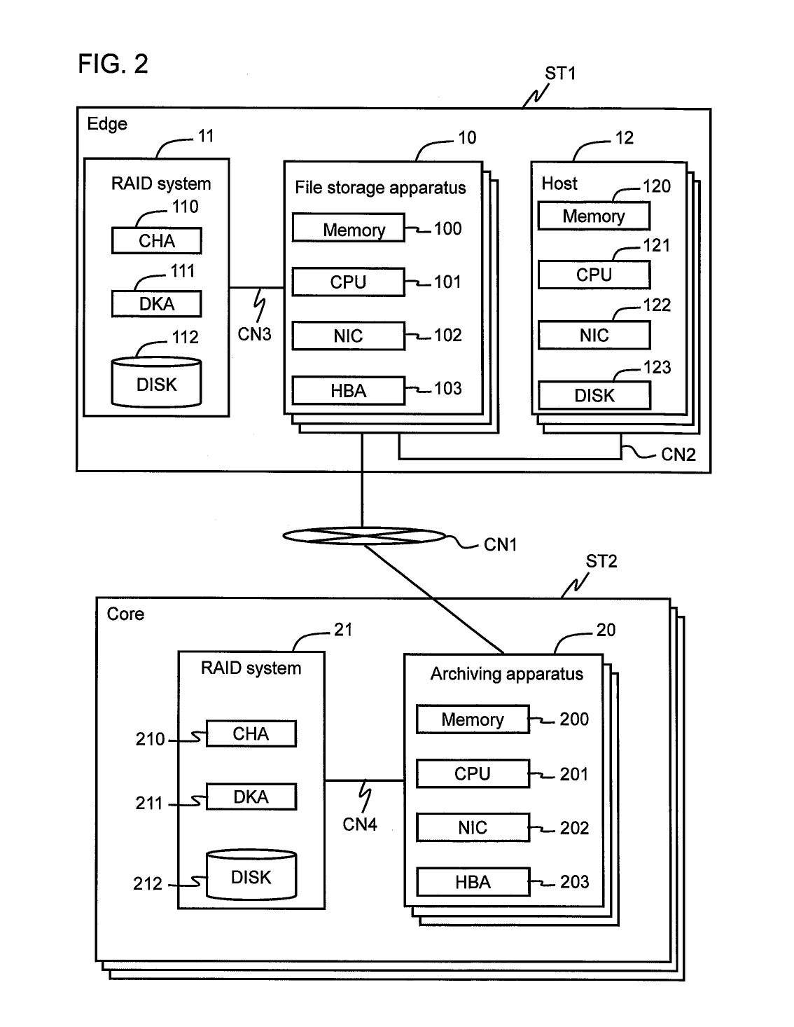

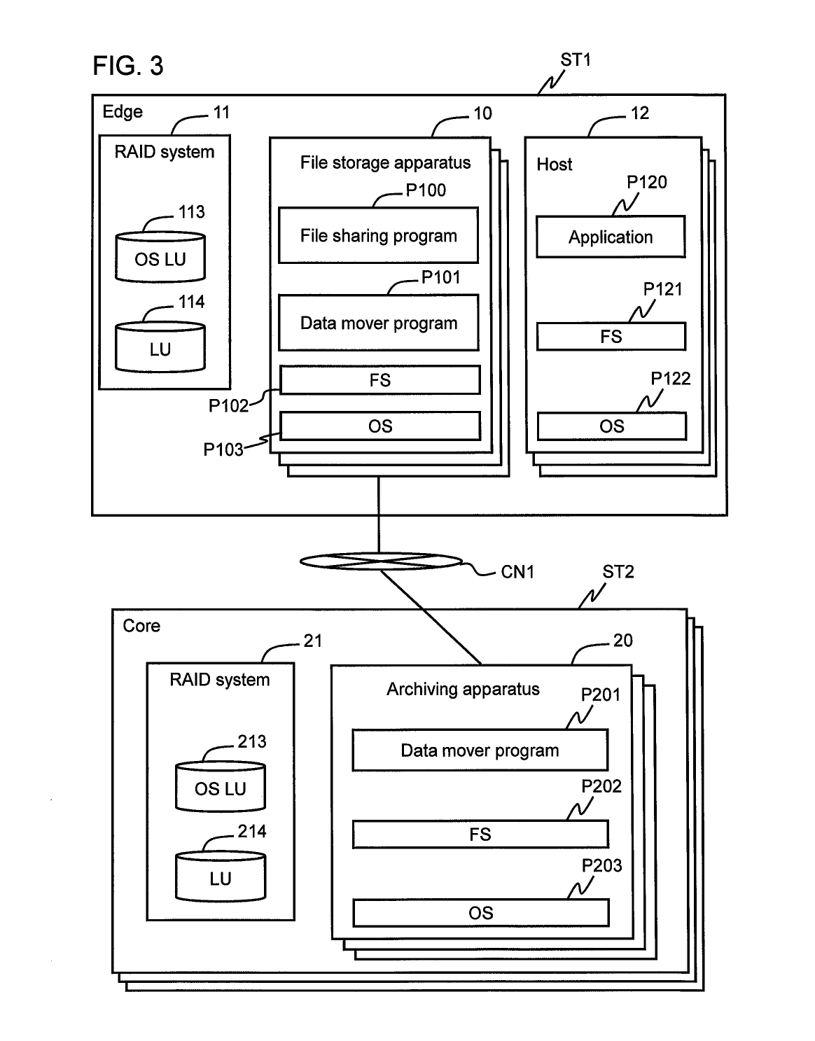

FIG. 2 is a hardware block diagram showing the overall configuration of a hierarchical storage system. FIG. 3 is a software block diagram of the hierarchical storage system. The corresponding relationship with FIG. 1 will be described first. A file storage apparatus 10 serving as the “first file management apparatus” corresponds to the edge-side file management apparatus 1 of FIG. 1, an archiving apparatus 20 serving as the “second file management apparatus” corresponds to the core-side file management apparatus 2 of FIG. 1, and a host 12 serving as the “user terminal” corresponds to the host in FIG. 1.

The management apparatus 3 of FIG. 1 is provided as a function of the file storage apparatus 10. More specifically, the functions performed by the management apparatus 3 are realized in accordance with the collaboration of a software group in the file storage apparatus 10 and a software group in the archiving apparatus 20.

The configuration of the edge-side site ST1 will be explained. The edge-side site ST1 is disposed on the user side, and, for example, is disposed in each business office or branch office. The edge-side site ST1, for example, is equipped with at least one file storage apparatus 10, at least one RAID (Redundant Arrays of Inexpensive Disks) system 11, and at least one host computer (or client terminal) 12.

The edge-side site ST1 and a core-side site ST2, for example, are coupled via a WAN or other such inter-site communication network CN1. The file storage apparatus 10 and the host computer (hereinafter, host) 12, for example, are coupled via an onsite communication network CN2 like a LAN (Local Area Network). The file storage apparatus 10 and the RAID system 11, for example, are coupled via a communication network CN3 such as either a FC-SAN (Fibre Channel-Storage Area Network) or an IP-SAN (Internet Protocol-SAN). Either multiple or all of these communication networks CN1, CN2, CN3 may be configured as a shared communication network.

The file storage apparatus 10, for example, comprises a memory 100, a microprocessor (CPU: Central Processing Unit in the drawing) 101, a NIC (Network Interface Card) 102, and a HBA Host Bus Adapter) 103.

The CPU 101 realizes a prescribed function, which will be explained further below, by executing prescribed programs P100 through P106 stored in the memory 100. The memory 100 can comprise a main storage memory, a flash memory device, or a hard disk device. The storage content of the memory 100 will be explained further below.

The NIC 102 is a communication interface circuit for the file storage apparatus 10 to communicate with the host 12 via the communication network CN2, and for the file storage apparatus 10 to communicate with the archiving apparatus 20 via the communication network CN1. The HBA 103 is a communication interface circuit for the file storage apparatus 10 to communicate with the RAID system 11.

The RAID system 11 manages, as block data, the data of a group of files managed by the file storage apparatus 10. The RAID system 11, for example, comprises a channel adapter (CHA) 110, a disk adapter (DKA) 111, and a storage device 112. The CHA 110 is a communication control circuit for controlling communications with the file storage apparatus 10. The DKA 111 is a communication control circuit for controlling communications with the storage device 112. Data inputted from the file storage apparatus 10 is written to the storage device 112 and data read from the storage device 112 is transferred to the file storage apparatus 10 in accordance with the collaboration of the CHA 110 and the DKA 111.

The storage device 112, for example, comprises a hard disk device, a flash memory device, a FeRAM (Ferroelectric Random Access Memory), a MRAM (Magnetoresistive Random Access Memory), a phase-change memory (Ovonic Unified Memory), or a RRAM (Resistance RAM: registered trademark).

The configuration of the host 12 will be explained. The host 12, for example, comprises a memory 120, a microprocessor 121, a NIC 122, and a storage device 123. The host 12 can be configured as a server computer, or can be configured as a personal computer or a handheld terminal (to include a cell phone).

An application program P120, which will be explained further below, is stored in the memory 120 and/or the storage device 123. The CPU 121 executes the application program and uses a file managed by the file storage apparatus 10. The host 12 communicates with the file storage apparatus 10 by way of the NIC 122.

The core-side site ST2 will be explained. The core-side site ST2, for example, is disposed in a data center or the like. The core-side site ST2 comprises the archiving apparatus 20 and a RAID system 21. The archiving apparatus 20 and the RAID system 21 are coupled via an in-site communication network CN4.

The RAID system 21 is the same configuration as the edge-side RAID system 11. A core-side CHA 210, DKA 211, and storage device 212 respectively correspond to the CHA 110, DKA 111, and storage device 112 of the edge side, and as such, explanations thereof will be omitted.

The archiving apparatus 20 is a file storage apparatus for backing up a group of files managed by the file storage apparatus 10. The archiving apparatus 20, for example, comprises a memory 200, a microprocessor 201, a NIC 202, and a HBA 203. Since the memory 200, the microprocessor 201, the NIC 202, and the HBA 203 are the same as the memory 100, the microprocessor 101, the NIC 102, and the HBA 103 of the file storage apparatus 10, explanations thereof will be omitted. The hardware configurations of the file storage apparatus 10 and the archiving apparatus 20 are alike, but their software configurations differ.

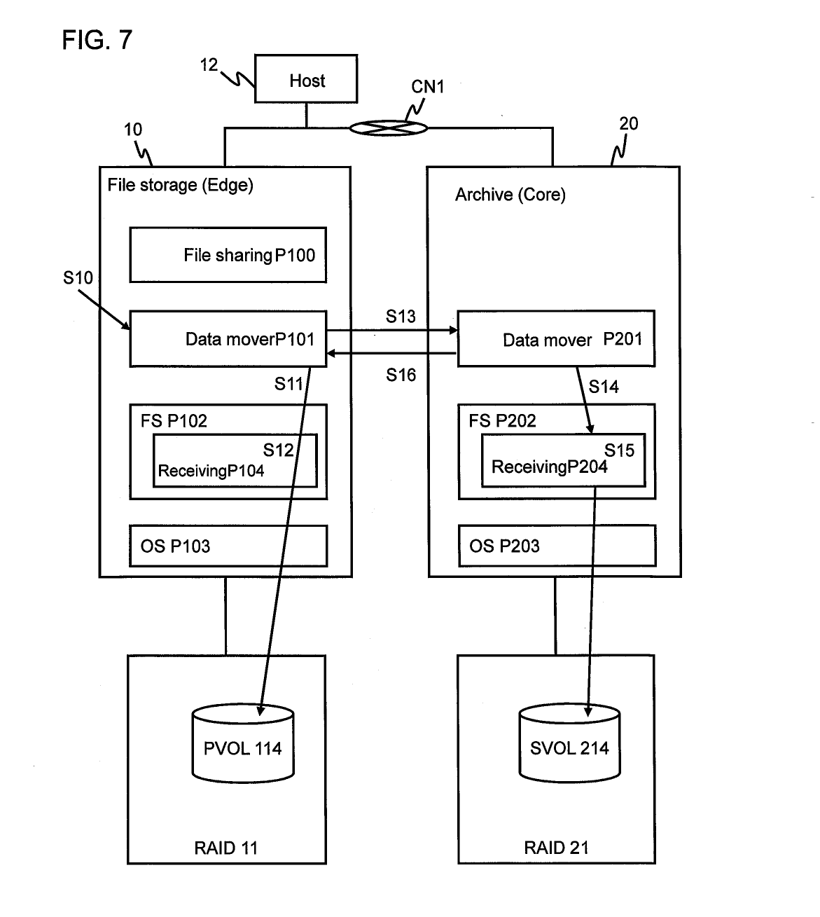

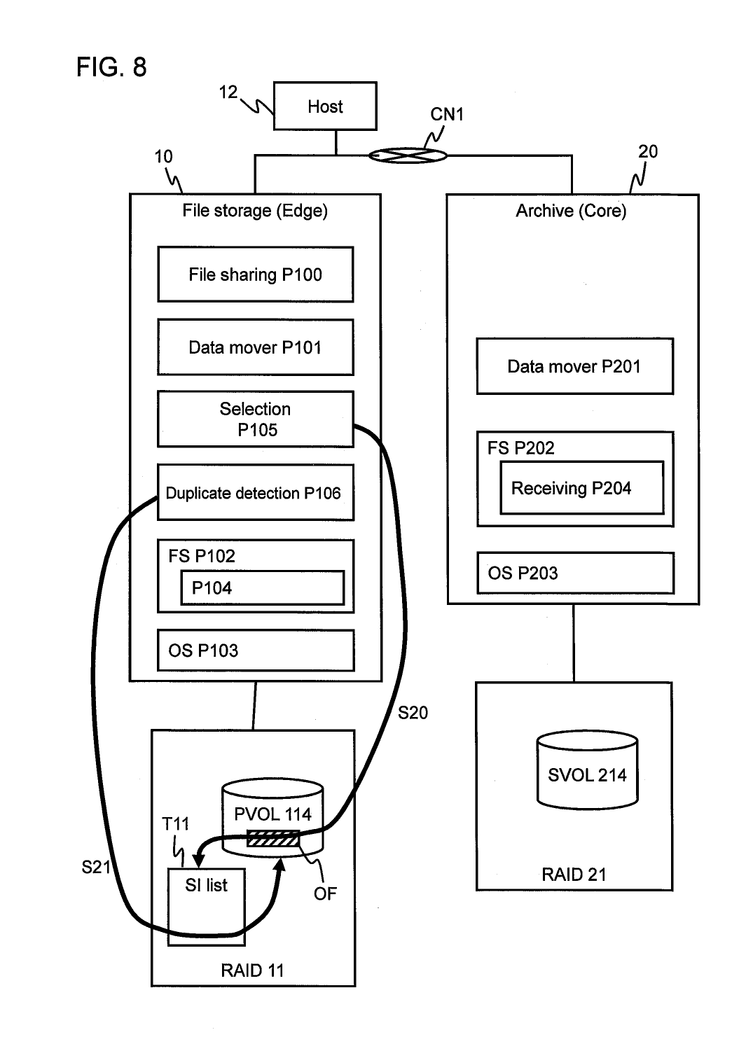

Refer to FIG. 3. The software configuration of the edge-side site ST1 will be explained first. The file storage apparatus 10, for example, comprises a file sharing program P100, a data mover program P101, a file system program (abbreviated as FS in the drawing) P102, and a kernel and driver (abbreviated as OS in the drawing) P103. In addition, the file storage apparatus 10, for example, comprises a receiving program P104 (refer to FIG. 7), a selection program P105 (refer to FIG. 8) and a duplicate detection program P106 (refer to FIG. 8).

The operation of each program will be explained further below, but briefly explained, the file sharing program P100, for example, is software for providing a file sharing service to the host 12 using a communication protocol like CIFS (Common Internet File System) or NFS (Network File System). The data mover program P101 is software for executing a replication process, a file synchronization process, a stubification process, and a recall process, which will be explained further below. The file system is a logical structure built for realizing a management unit called a file on a volume 114. The file system program P102 is software for managing the file system.

The kernel and driver P103 are software for controlling the file storage apparatus 10 as a whole. The kernel and driver P103, for example, control the scheduling of multiple programs (processes) running on the file storage apparatus 10, and control an interrupt from a hardware component.

The receiving program P104 is software for receiving a file access request from the host 12, performing a prescribed process, and returning the result thereof. The selection program P105 is software for selecting a single instance candidate for applying a single instance process. The duplicate detection program P106 is software for carrying out a single instance process for a selected single instance candidate.

The RAID system 11 comprises a logical volume 113 for storing an OS and the like, and a logical volume 114 for storing file data. The logical volumes 113, 114, which are logical storage devices, can be created by collecting the physical storage areas of multiple storage devices 112 together into a single storage area and clipping storage areas of a prescribed size from this physical storage area.

The host 12, for example, comprises an application program (abbreviated as application hereinafter) P120, a file system program P121, and a kernel and driver P122. The application P120, for example, comprises a word-processing program, a customer management program, or a database management program.

The software configuration of the core-side site ST2 will be explained. The archiving apparatus 20, for example, comprises a data mover program P201, a file system P202, and a kernel and driver P203. The role of these pieces of software will explained further below as needed.

The RAID system 21, for example, comprises a logical volume 213 for storing a OS or the like, and a logical volume 214 for storing file data the same as the RAID system 11. Explanations thereof will be omitted.

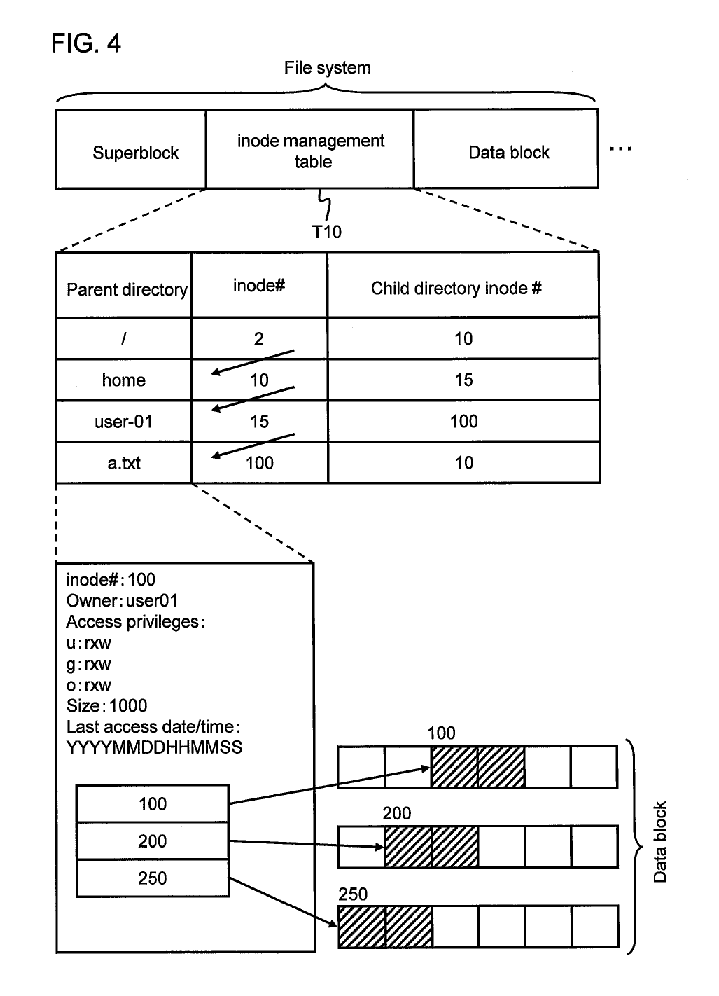

FIG. 4 is an illustration showing the relationship between a file system and an inode management table T10 in simplified form. As shown at the top of FIG. 4, the file system, for example, comprises a superblock, an inode management table T10, and a data block.

The superblock, for example, is an area for collectively storing file system management information, such as the size of the file system and the file system free capacity. The inode management table T10 is management information for managing an inode, which is configured in each file.

One inode each is correspondingly managed for each directory or file in the file system. Of the respective entries in the inode management table T10, an entry comprising only directory information is called a directory entry. The inode in which a target file is stored can be accessed by using the directory entry to follow a file path. For example, when following “/home/user-01/a.txt” as shown in FIG. 4, the data block of the target file can be accessed by following inode #2->inode #10->inode #15->inode #100, in that order.

The inode in which the file entity is stored (“a.txt” in the example of FIG. 4), for example, comprises information such as the file owner, access privileges, the file size, and the data storage location. At the bottom of FIG. 4, the reference relationship between the inode and the data block is shown. The numerals 100, 200, 250 assigned to the data block in FIG. 4 denote a block address. The “u” displayed in the access privileges items is an abbreviation for user, the “g” is the abbreviation for group, and the “o” is the abbreviation for a person other than the user. Also, the “r” shown in the access privileges items is the abbreviation for read, the “x” is the abbreviation for execute, and the “w” is the abbreviation for write. The last access date/time is recorded as a combination of the year (four digits), month, day, hour, minute, and second.

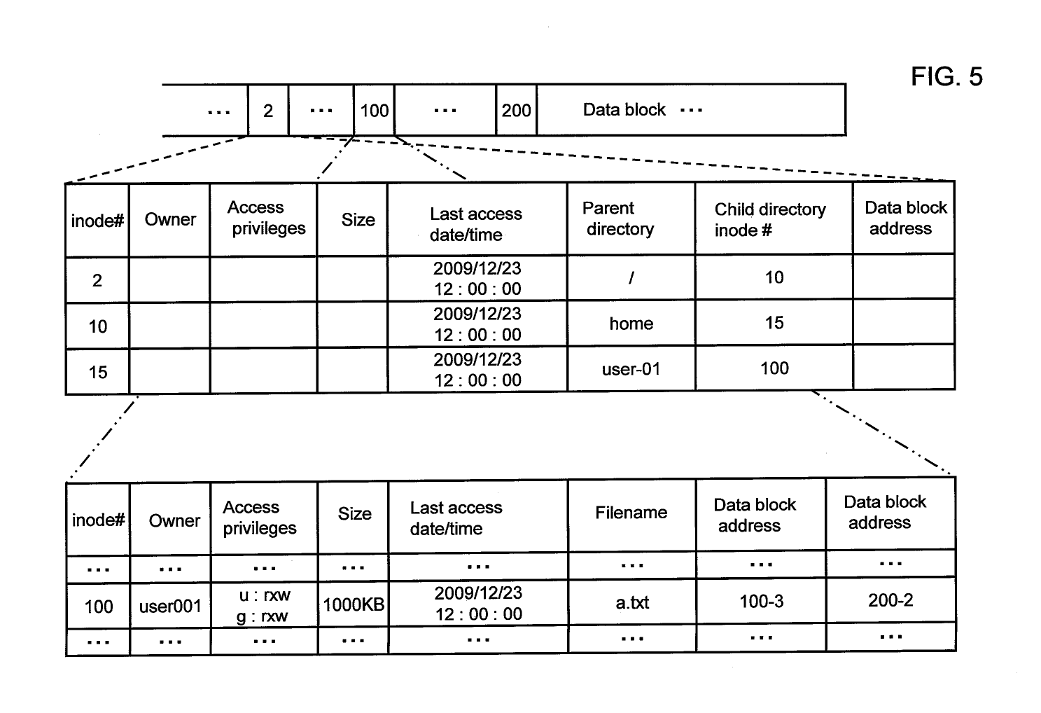

FIG. 5 shows a state in which an inode is stored in the inode management table. In FIG. 5, inode numbers “2” and “100” are given as examples.

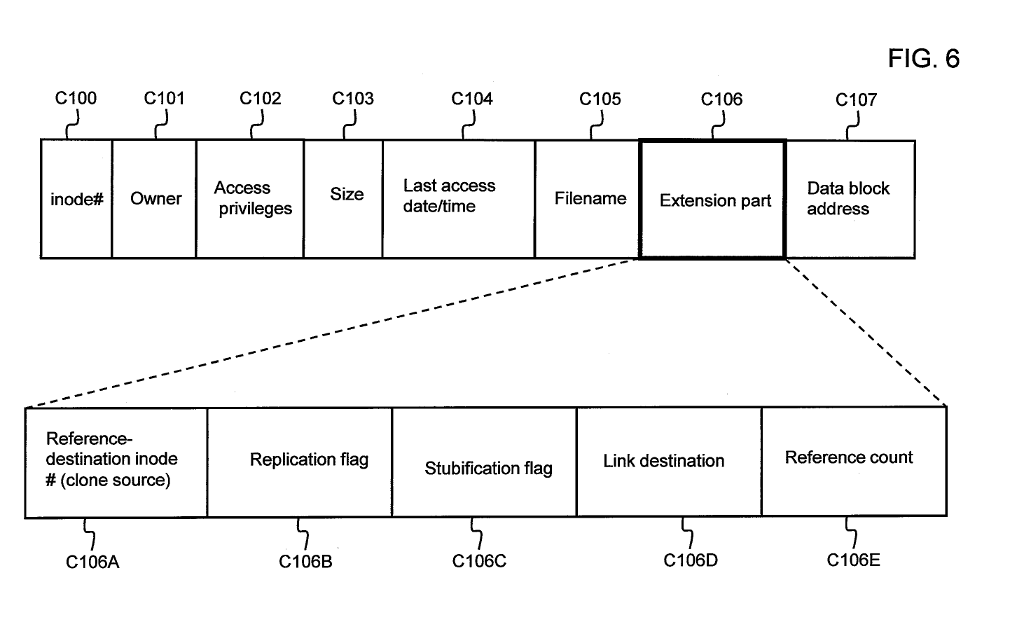

FIG. 6 is an illustration showing the configuration of a part, which has been added to the inode management table T10 in this example. The inode management table T10, for example, comprises an inode number C100, an owner C101, an access privileges C102, a size C103, a last access date/time C104, a filename C105, an extension part C106, and a data block address C107.

The extension part C106 is a characteristic part added for the purpose of this example, and, for example, comprises a reference-destination inode number C106A, a replication flag C106B, a stubification flag C106C, a link destination C106D, and a reference count C106E.

The reference-destination inode number C106A is information for identifying a data reference-destination inode. In the case of a clone file, a clone-source file inode number is configured in the reference-destination inode number C106A. In the case of a clone-source file, a value is configured in the reference-destination inode number C106A. This is because a reference destination does not exist.

The replication flag C106B is information showing whether or not a replication process as ended. In a case where a replication process has ended and a replica has been created in the archiving apparatus 20, ON is configured in the replication flag. In a case where a replication process has not been performed, that is, a case in which a replica has not been created in the archiving apparatus 20, the replication flag is configured to OFF.

The stubification flag C106C is information showing whether or not a stubification process has been performed. In a case where a stubification process has been performed and a file has been converted to a stubified file, ON is configured in the stubification flag. In a case where a file has not been converted to a stubified file, the stubification flag is configured to OFF.

The link destination C106D is link information for referencing a replicated file inside the archiving apparatus 20. In a case where a replication process has been completed, a value is configured in the link destination C106D. In a case where the file storage apparatus 10 performs a recall process or the like, replicated file data can be acquired from the archiving apparatus 20 by referencing the link destination C106D.

The reference count C106E is information for managing the life of a clone-source file. The value of the reference count C106E is incremented by 1 every time a clone file, which references the clone-source file, is created. Therefore, for example, “5” is configured in the reference count C106E of a clone-source file, which is referenced from five clone files.

The value of the reference count C106E is decremented by 1 when a clone file, which references the clone-source file, is either deleted or stubified. Therefore, in the above-mentioned case, the value of the reference count C106E transitions to “3” in a case where one clone file has been deleted, and another clone file has been stubified. When the value of the reference count C106E reaches 0, the clone-source file is deleted. In this example, when the clone files, which reference a clone-source file, are gone, this clone-source file is deleted and the free area increases.

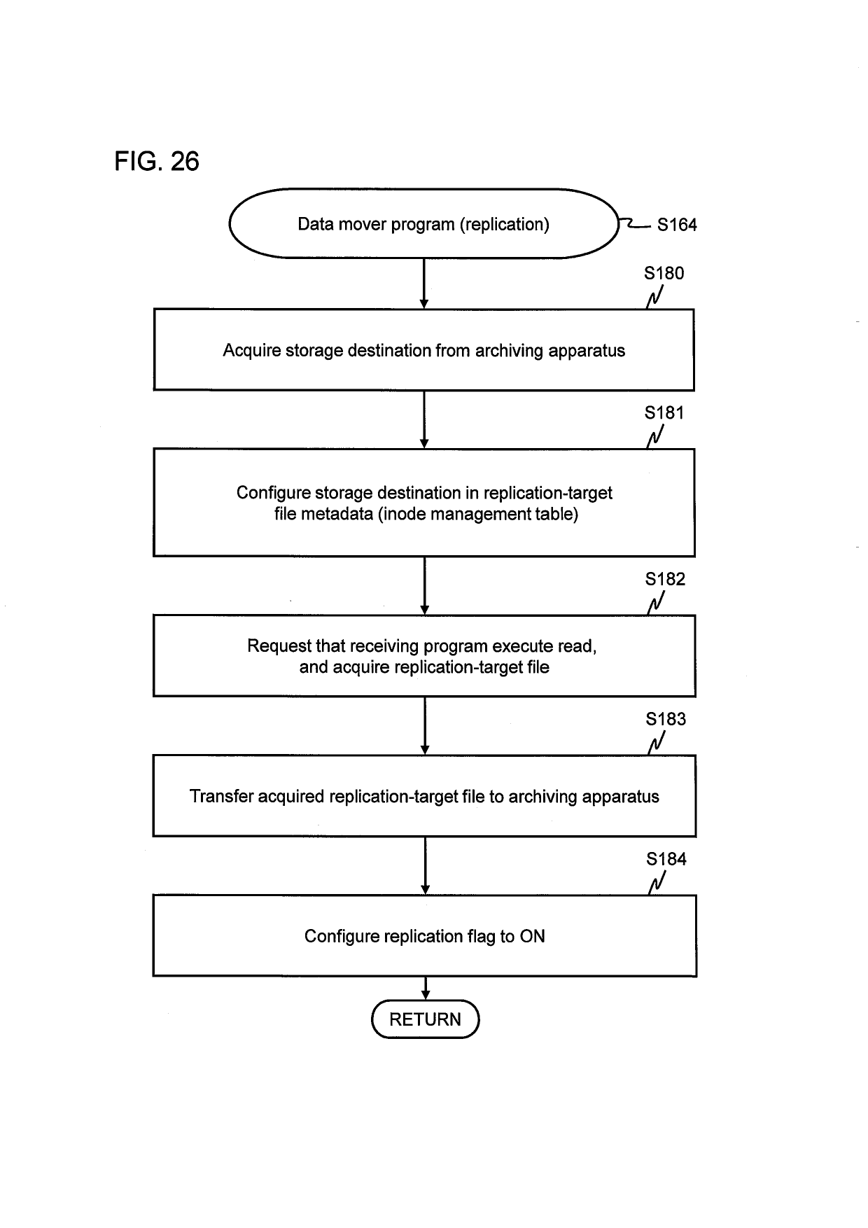

FIG. 7 shows an overview of the replication process. The replication process will be explained in detail further below using FIG. 26.

The data mover program P101 of the file storage apparatus 10 regularly receives a replication request (S10). The replication request, for example, is issued by the host 12. The replication request comprises a replication-target filename and so forth.

The data mover program P101 issues a read request to the receiving program P104 to acquire the file data targeted for replication (S11). The receiving program P104 reads the data of the replication-target file from the primary volume (the logical volume, which is the copy source) 114 in the RAID system 11, and delivers this data to the data mover program P101 (S12).

The data mover program P101 sends the acquired file data and metadata to the data mover program P201 of the archiving apparatus 20 (S13). The data mover program P201 of the archiving apparatus 20 issues a write request to the receiving program P204 of the archiving apparatus 20 (S14). The receiving program P204 writes the file acquired from the file storage apparatus 10 to the RAID system secondary volume (the copy-destination logical volume) 214 (S15). The metadata sent together with the file data block, for example, is the inode management table T10.

When a replica is created in the archiving apparatus 20, the replication flag C106B of the replication-source file is configured to ON. The configuration may be such that a list of replicated files recording a replication filename is used instead of the replication flag to manage a replicated file.

A replication-source file in the primary volume 114 and a replication file in the secondary volume 214 are associated as a pair. When the replication-source file is updated, the file is re-transferred to the archiving apparatus 20. In accordance with this, the replication-source file inside the file storage apparatus 10 and the replication file inside the archiving apparatus 20 are synchronized.

In this example, a file, which is targeted for a file synchronization process, is managed using a list. That is, in a case where a file, which has undergone replication processing, is updated, this file is recorded on a list. The file storage apparatus 10 transfers the file recorded on the list to the archiving apparatus 20 at the appropriate time. Instead of the list, a flag denoting the need for synchronization may be added to the inode management table T10. When a file has been updated, the flag denoting whether or not synchronization is needed for this file is configured to ON, and when the file synchronization process has ended, this flag is configured to OFF.

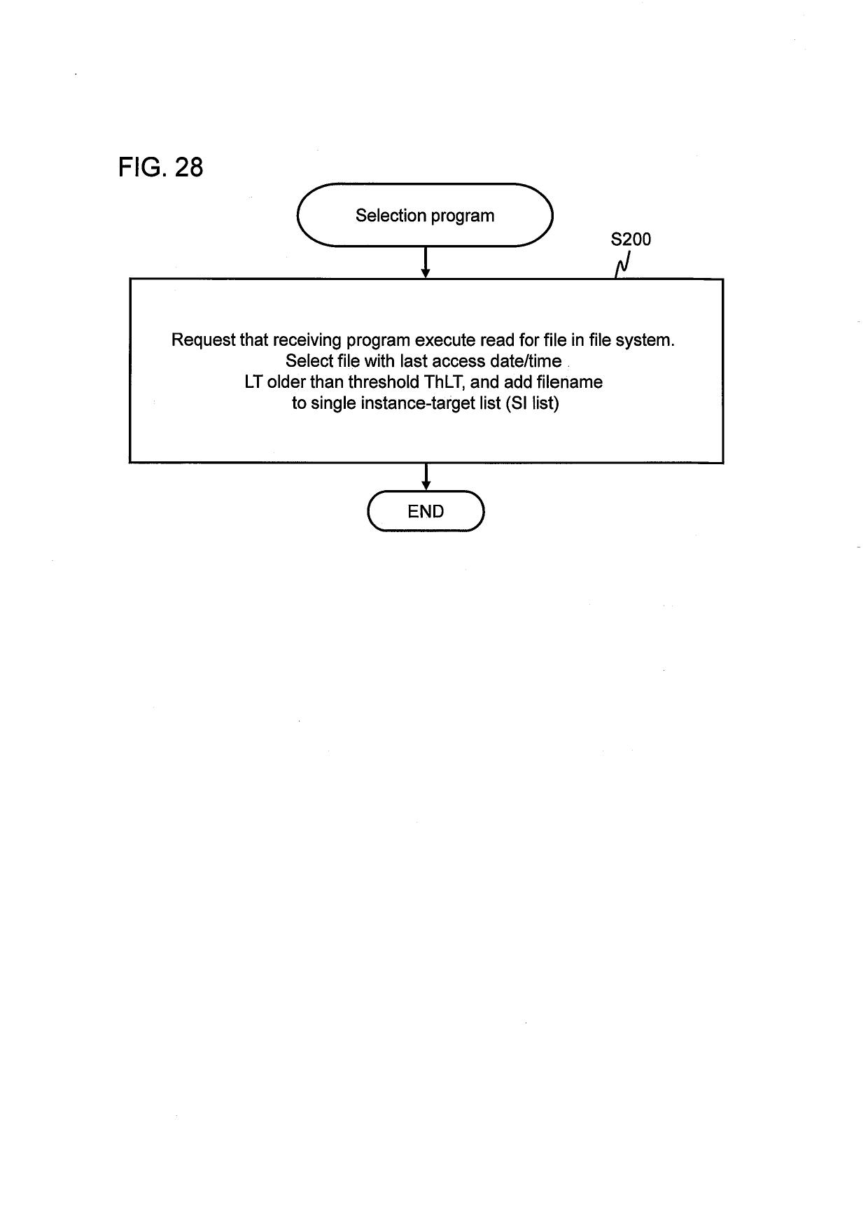

FIG. 8 shows an overview of the single instance process. The single instance process will be explained in detail further below using FIGS. 28, 29 and 30.

The selection program P105 regularly searches for a file, which has not been accessed for a defined period of time (for example, a file, which has not been updated for a defined period of time), and creates a list T11 for recording the name of the relevant file (S20). The list T11 is information for managing a file, which will become a candidate for a single instance process.

The duplicate detection program P106, which is executed regularly, compares a single instance process candidate file recorded on the list T11 to an existing clone-source file. In a case where the candidate file and the existing clone-source file are a match, the duplicate detection program P106 deletes the data in the candidate file (S21). The duplicate detection program P106 configures the inode number of the clone-source file in the reference-destination inode number C106A of the candidate file inode management table T10 (S21). In accordance with this, this candidate file is converted to a clone file, which references the clone-source file.

In a case where the candidate file and the existing clone-source file do not match, the duplicate detection program P106 creates a new clone-source file corresponding to this candidate file. The duplicate detection program P106 deletes the data of the candidate file, and, in addition, configures the inode number of the newly created clone-source file in the reference-destination inode number C106A of the candidate file.

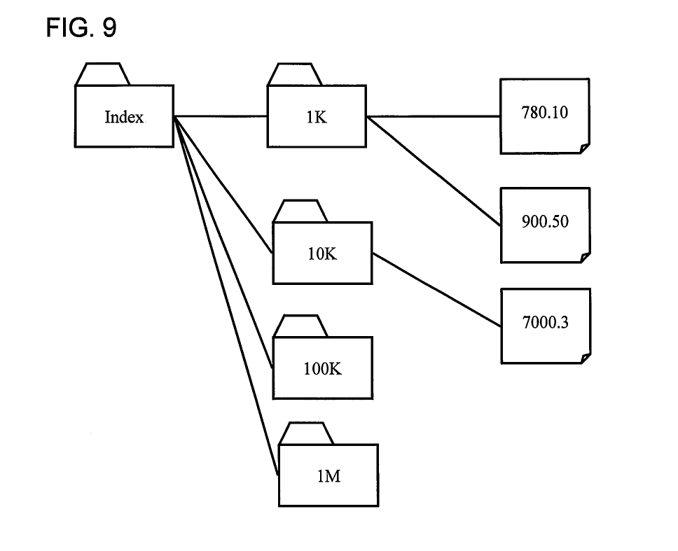

FIG. 9 is an illustration showing a clone-source file management method. The clone-source file, as was explained hereinabove, is an important file for storing data to be referenced from one or multiple clone files. Therefore, in this example, the clone-source file is managed under a specific directory inaccessible to the user in order to protect the clone-source file from user error. This specific directory is called the index directory in this example.

A subdirectory is provided in the index directory for each file size ranking such as, for example, “1K”, “10K”, “100K” and “1M”. The clone-source file is managed using a subdirectory corresponding to its own file size. The filename of the clone-source file, for example, is created as a combination of the file size and the inode number.

The filename of a clone-source file having a file size of 780 bytes and an inode number of 10 becomes “780.10”. Similarly, the filename of a clone-source file having a file size of 900 bytes and an inode number of 50 becomes “900.50”. These two clone-source files “780.10” and “900.50” are managed using the “1 KB” subdirectory for managing a clone-source file of less than 1 KB.

A clone-source file having a file size of 7000 bytes and an inode number of 3 is managed in the “10K” subdirectory for managing a clone-source file with a file size of equal to or larger than 1 KB but less than 10 KB.

Thus, in this example, a clone-source file is classified by file size and stored in a subdirectory, and, in addition, a combination of the file size and the inode number is used as the filename. Therefore, the clone-source file to be compared to the clone-candidate file (the single instance process candidate file) can be selected quickly, making it possible to complete query processing in a relatively short period of time.

Instead of a combination of the file size and the inode number, for example, the filename of the clone-source file may be created from a combination of the file size and a hash value, or a combination of the file size, the inode number, and a hash value. The hash value is obtained by inputting the clone-source file data to a hash function.

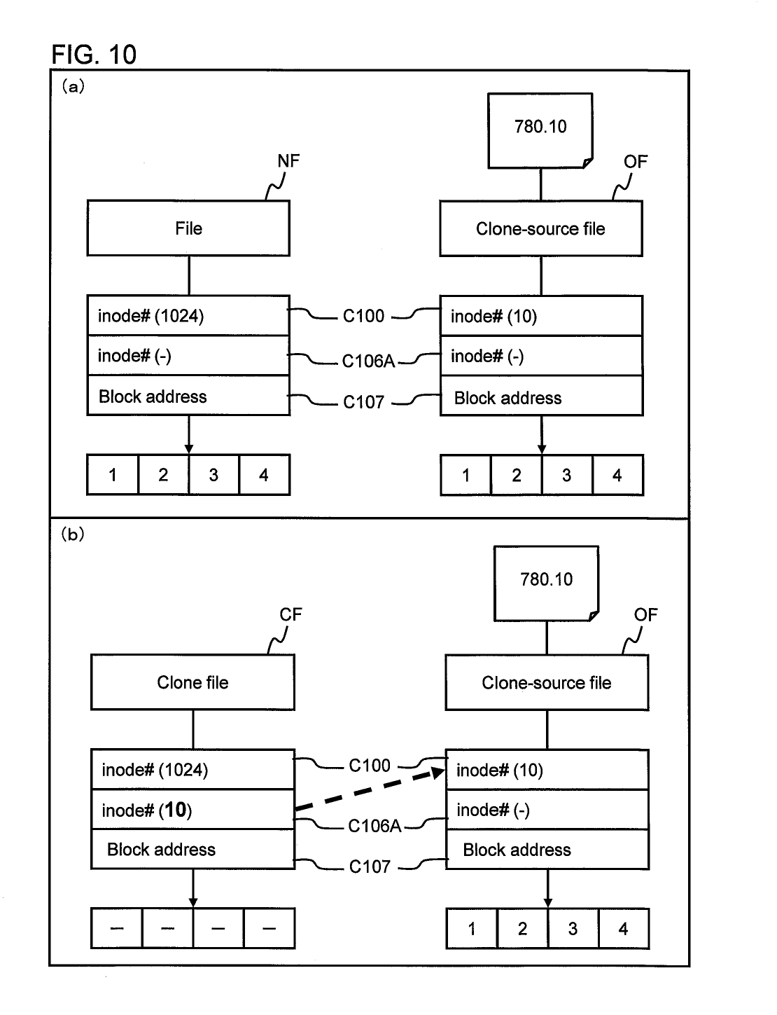

FIG. 10 shows how a file recorded in the list T11 as a single instance processing candidate is converted to a clone file. A clone-candidate file NF is shown on the left side of FIG. 10(a). On the right side of FIG. 10(a), an existing clone-source file OF is shown. A portion of the metadata is shown in FIG. 10 for the sake of convenience.

The data of the clone-candidate file NF and the clone-source file OF are both “1234”, and both data match. Consequently, as shown in FIG. 10(b), the file storage apparatus 10 deletes the data of the clone-candidate file, and, in addition, configures “10”, which is the inode number of the clone-source file, in the reference-destination inode number C106A of the clone-candidate file. In accordance with this, the clone-candidate file NF is converted to a clone file CF, which references the clone-source file OF. Duplicate data, i.e., the clone file data matching that of the clone-source file, can be removed in data block units since all of the data in the clone-source file is referenced.

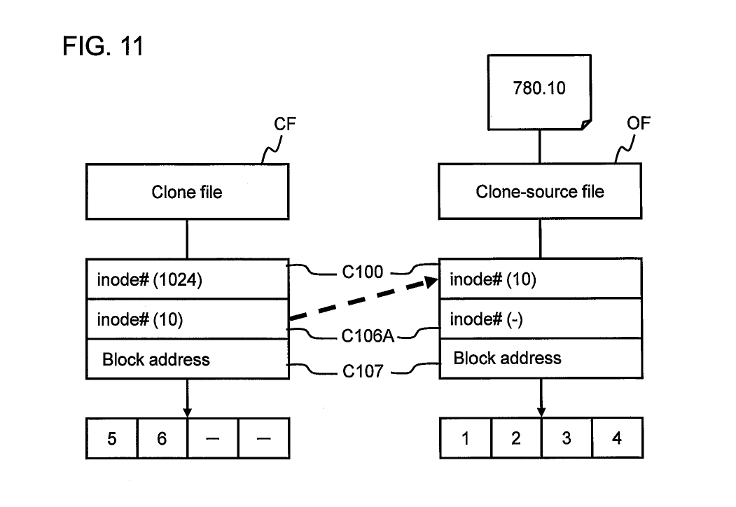

FIG. 11 shows a case in which a clone file is updated. In a case where the clone file is updated by the host 12 and is a partial mismatch with the data of the clone-source file, the clone file stores only the difference data with respect to the clone-source file. In the example of FIG. 11, the two data blocks at the head of the clone file are updated from “1” and “2” to “5” and “6”. Consequently, the clone file stores only the “5” and “6”, which are the difference data, and continues to reference the clone-source file for the other data “3” and “4”.

Although not shown in particular in the drawing, either one or both of the clone-source file and the clone file may be compressed using run-length or some other such data compression method. The storage area of the file storage apparatus 10 can be used even more efficiently by performing data compression.

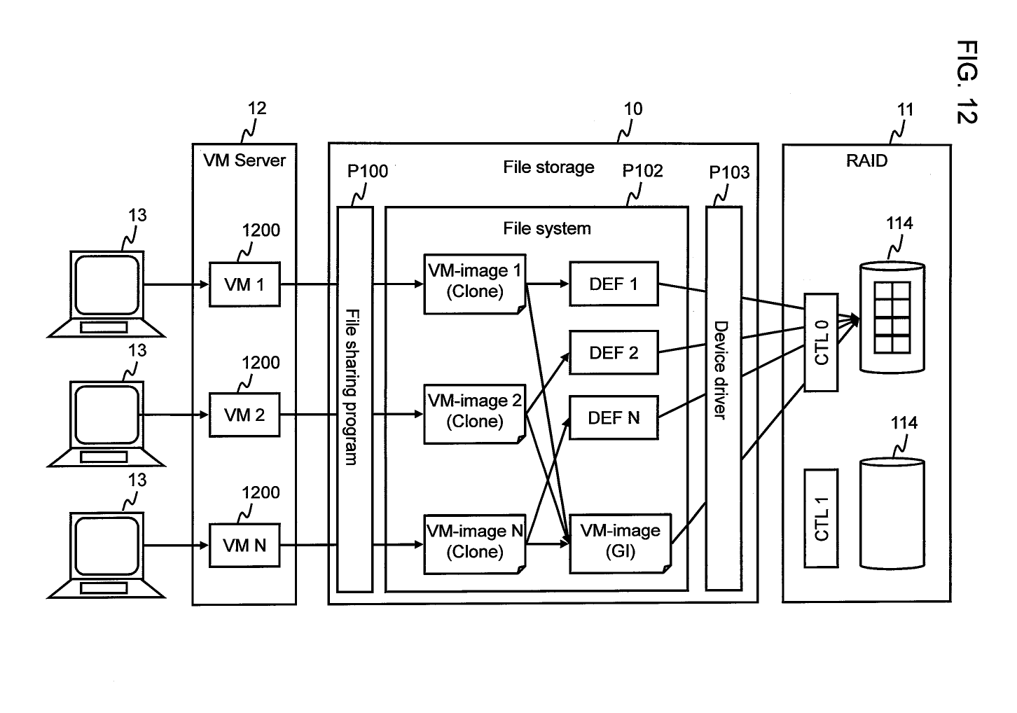

A number of examples of applications of the single instance process will be explained by referring to FIGS. 12 through 14. In FIGS. 12 through 14, only the configuration of the edge-side site is shown. FIG. 12 is a case where single instance processing is applied to a virtual desktop environment.

In the example of FIG. 12, the host 12 is configured as a virtual server, and boots up multiple virtual machines 1200. A client terminal 13 operates on a file via each virtual machine 1200. The client terminal 13, for example, can be configured as a thin client terminal, which does not comprise an auxiliary storage device.

A file system in the file storage apparatus 10 manages a boot disk image of the virtual machine 1200 (VM-image) as a clone file. Each boot disk image, which has been made into a clone file, references a golden image (GI). Difference data between each boot disk image and the golden image is respectively managed as difference data (DEF).

Thus, in a case where single instance processing has been applied to a virtual desktop environment, the size of the boot disk image of the virtual machine can be reduced. Therefore, the data storage area as a whole can be made smaller even in a case where a large number of virtual machines 1200 has been created.

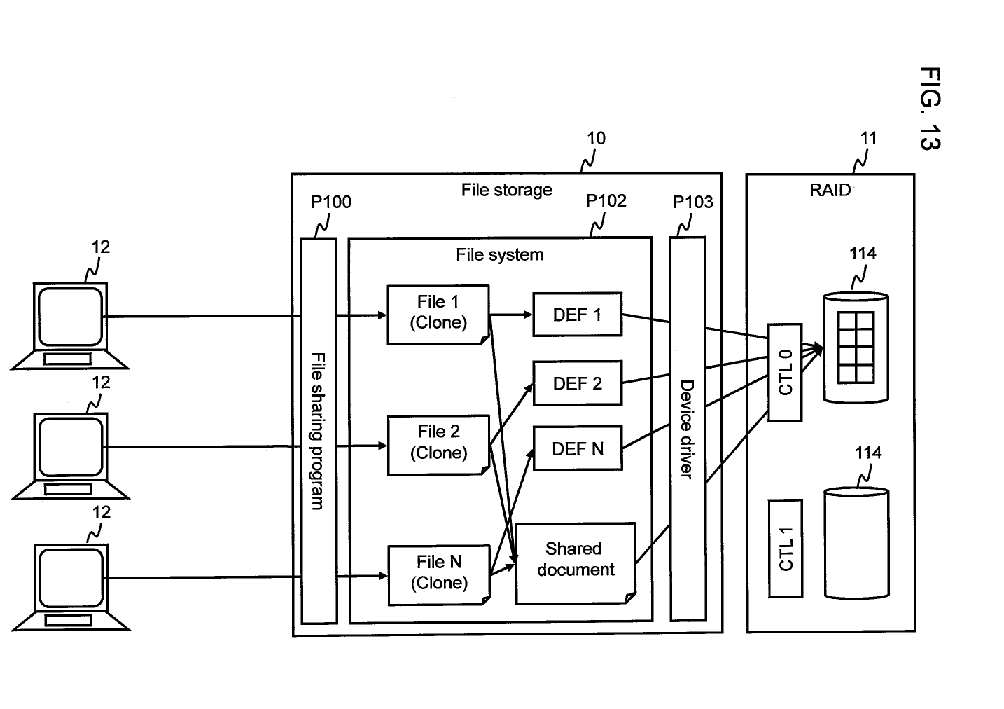

FIG. 13 shows an example of a case where single instance processing is applied to a document management system. The file system of the file storage apparatus 10 manages a shared document, which is being shared by multiple client terminals 12, and multiple related documents derived from the shared document.

A related document derived from the shared document is a clone file, which references the shared document as a clone-source file. Thus, in a case where multiple users create related documents based on the shared document, the storage area can be used efficiently when the related document is created as a clone file.

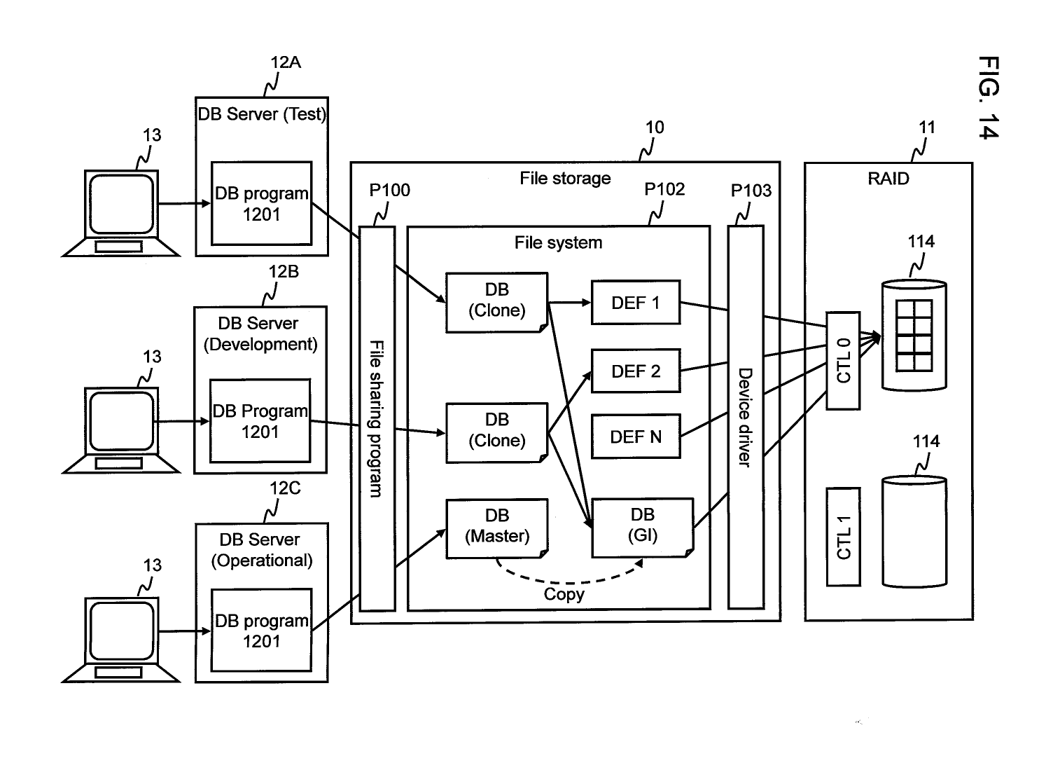

FIG. 14 is an example showing a case in which single instance processing is applied to a database system. A database server 12A for test use, a database server 12B for development use, and a database server 12C for operational use each comprise a database program 1201. The user accesses via the client terminal 13 the server, which he is authorized to use from among the servers 12A through 12C, and uses the database.

The file system of the file storage apparatus 10 manages a master table, a golden image, which is a copy of the master table, and a clone database, which is created as a clone file for referencing the golden image.

The database development programs 1201 of the test database server 12A and the development database server 12B use databases, which have respectively been created as clone files. Difference data between a database created as a clone file and the golden image is correspondingly managed with the database created as a clone file.

Thus, in a case where database access is provided to multiple client terminals 13, the storage area can be used efficiently when a database, which is created as a clone file, is prepared for each database application.

A number of examples of applying single instance processing have been described above, but the description given above is merely an example, and the present invention can be applied to other configurations as well.

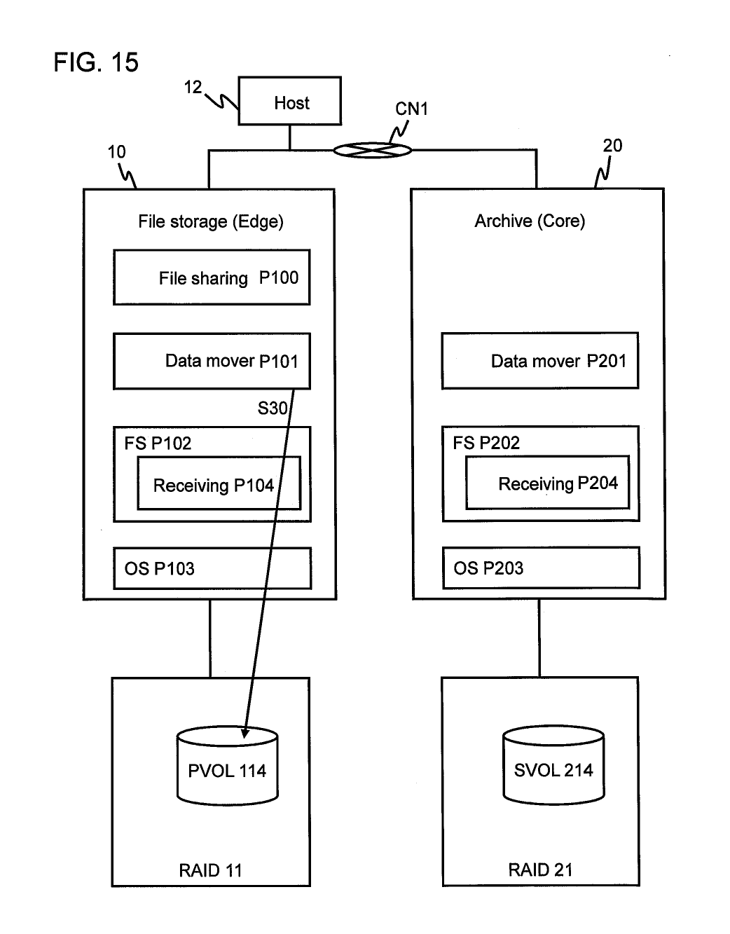

FIG. 15 shows an overview of the stubification process. The data mover program P101 boots up at defined times and checks the free capacity of the primary volume 114, and in a case where the free capacity is less than a threshold, performs stubification in order from the file with the oldest last access date/time (S30).

Stubification refers to a process for making a target file a stubified file. The stubification process deletes data on the file storage apparatus 10 side, and only leaves the data of the replicated file of the archiving apparatus 20. When the host 12 accesses a stubified file, the data of the stubified file is read from the archiving apparatus 20, and stored in the file storage apparatus 10 (a recall process).

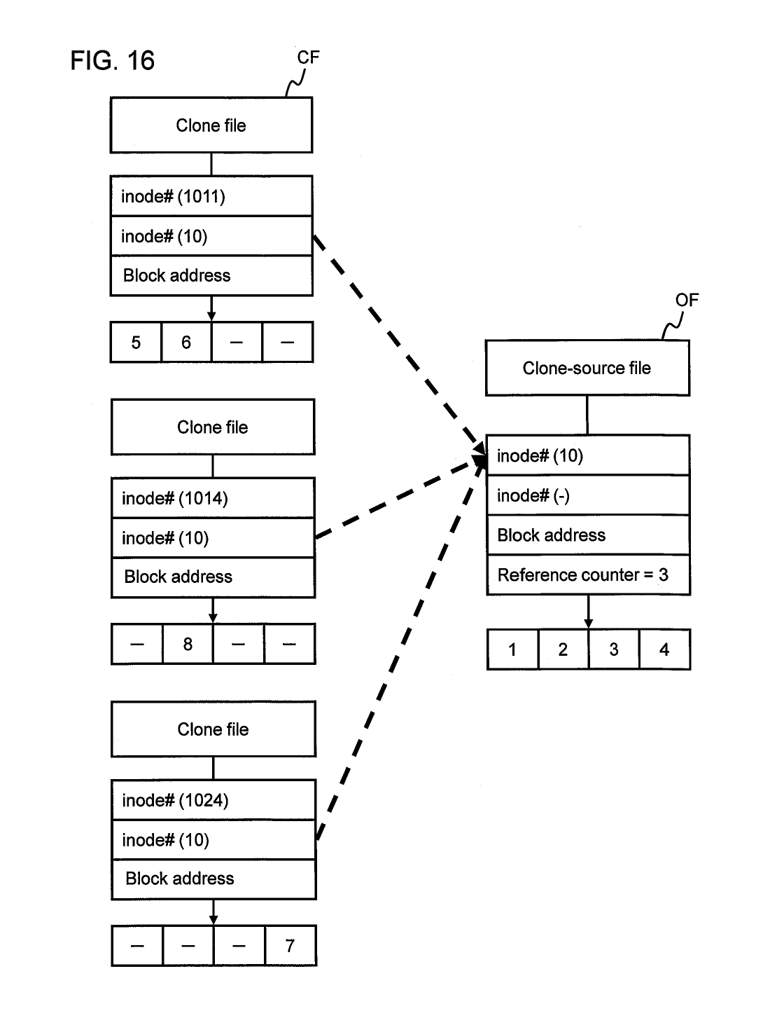

FIG. 16 shows a clone-source file delete condition. As was explained with respect to the reference count C106E of FIG. 6, every time a clone file, which has the clone-source file as a reference destination, is created, the value of the reference count C106E of the clone-source file is incremented by 1. Alternatively, when a clone file is converted to a stubified file, or when a clone file is deleted, the reference count C106E value is decremented by 1 each time. Then, at the point in time when the value of the reference count C106E reaches 0, there are no longer any clone files directly referencing this clone-source file, and the clone-source file becomes a delete target.

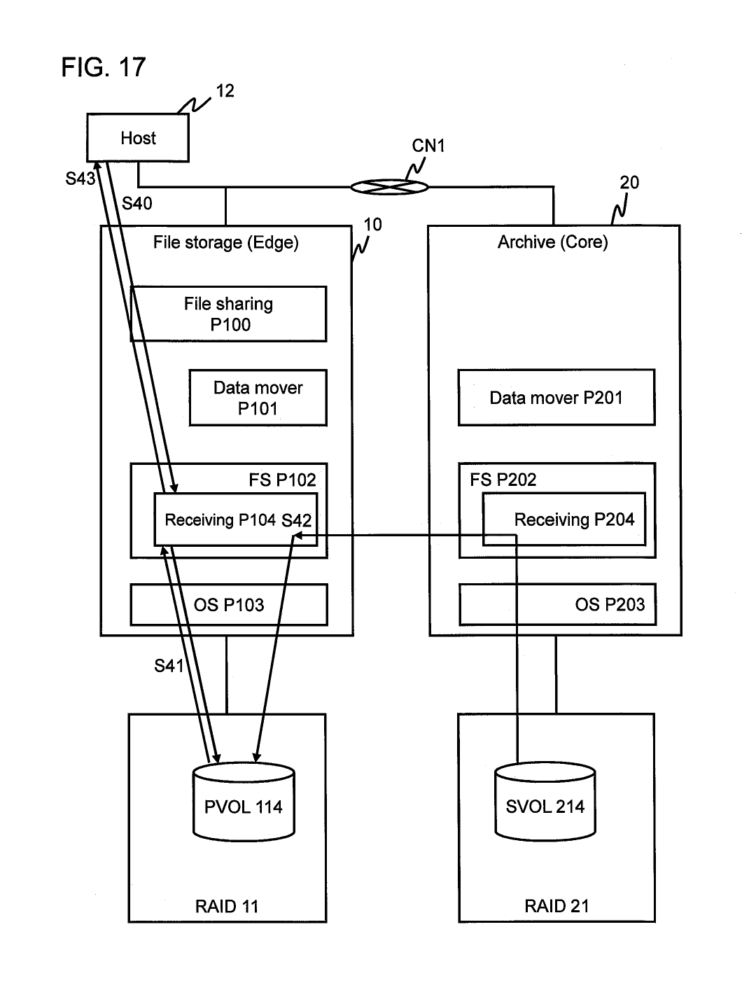

FIG. 17 shows an overview of a read request process by the receiving program P104. The receiving program P104, upon receiving a read request from the host 12 (S40), acquires the read-target file from the primary volume 114 (S41).

In a case where the read-target file has been stubified, or there is no data in the primary volume 114, the receiving program P104 implements a recall process and reads the data of the read-target file from the secondary volume 214 (S42). The receiving program P104 transfers the data read from the secondary volume 214 of the archiving apparatus 20 to the host 12 after storing this data in the primary volume 114 (S43).

When the read-target file has been recalled, the receiving program P104 reads this file data from the primary volume 114 and transfers it to the host 12. Since the file storage apparatus 10 is being shared by multiple hosts 12, there may be cases in which a read-target stubified file is recalled in accordance with another access request received earlier. Whether or not a recall has been completed can be determined by checking whether the value of the block address C107 of the inode management table T10 is 0 or not. In a case where a recall has been completed, a value other than 0 is configured in the block address.

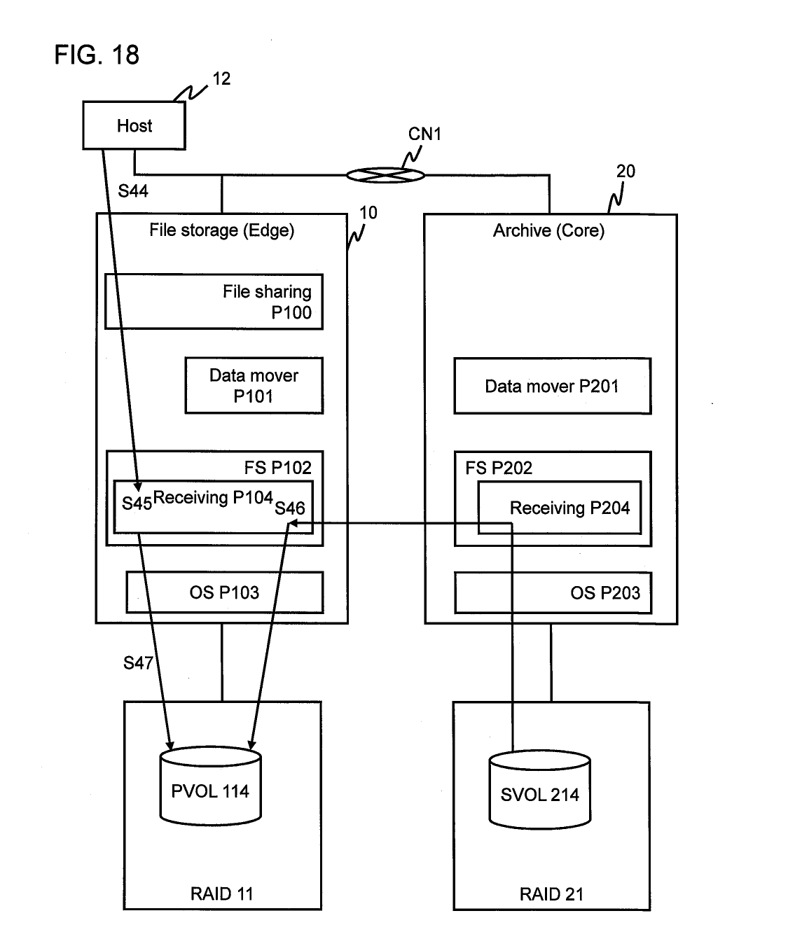

FIG. 18 shows an overview of a write request process by the receiving program P104. The receiving program P104, upon receiving a write request from the host 12 (S44), checks whether or not the write-target file has been converted to a stubified file (S45).

In a case where the write-target file has been converted to a stubified file, that is, a case in which the write-target file is stubified, the receiving program P104 acquires all the data of the write-target file from the archiving apparatus 20. The receiving program P104 writes the acquired data to the file system of the file storage apparatus 10, and configures the stubification flag C106C of the write-target file to OFF (S46).

Then, the receiving program P104 writes the write data to the write-target file, and, in addition, records the name of the write-target file in an update list (S47). Since the content of the write-target file changes in accordance with the write data being written thereto, the write-target file is made the target of a file synchronization. In a case where the write-target file has not been stubified, the above-described Step S46 is omitted, and Step S47 is executed.

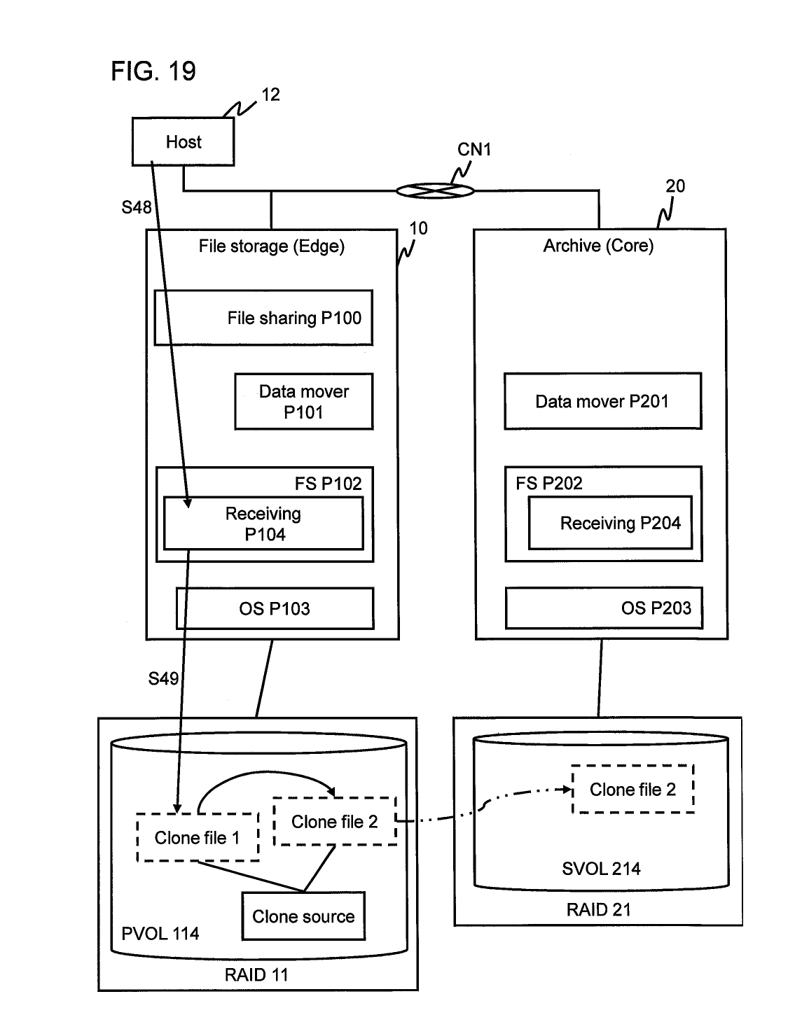

FIG. 19 shows an overview of a file copy process. The users, who are sharing the file storage apparatus 10, can reuse a file in the file storage apparatus 10 as needed, and can create a new file.

When a file is reused, a copy of the file is made. All of the data may be copied exactly as-is as is done for a normal file, but duplicate data is stored in the file storage apparatus 10 in accordance with this. Consequently, in this example, a single instance process is used to reduce stored capacity at file copy creation.

The receiving program P104, upon receiving a copy request from the host 12 (S48), creates a copy (a clone file 2) of the file selected as the copy source (the clone file 1 of FIG. 19) (S49). That is, the receiving program P104 creates a copy of the specified file by copying only the metadata rather than copying the data.

In a case where the file specified as the copy-source file is not a clone file (a case of a non-clone file such as a normal file), the receiving program P104 first converts the copy-source file to a clone file.

Next, the receiving program P104 creates a copy file (which is a clone file) by copying the metadata (the inode management table T10) of the copy-source file, which was converted to a clone file, and reusing a portion of this metadata. Since the number of clone files increases, the value of the reference count C106E of the clone-source file, which is the reference destination of this clone file, is incremented by 1.

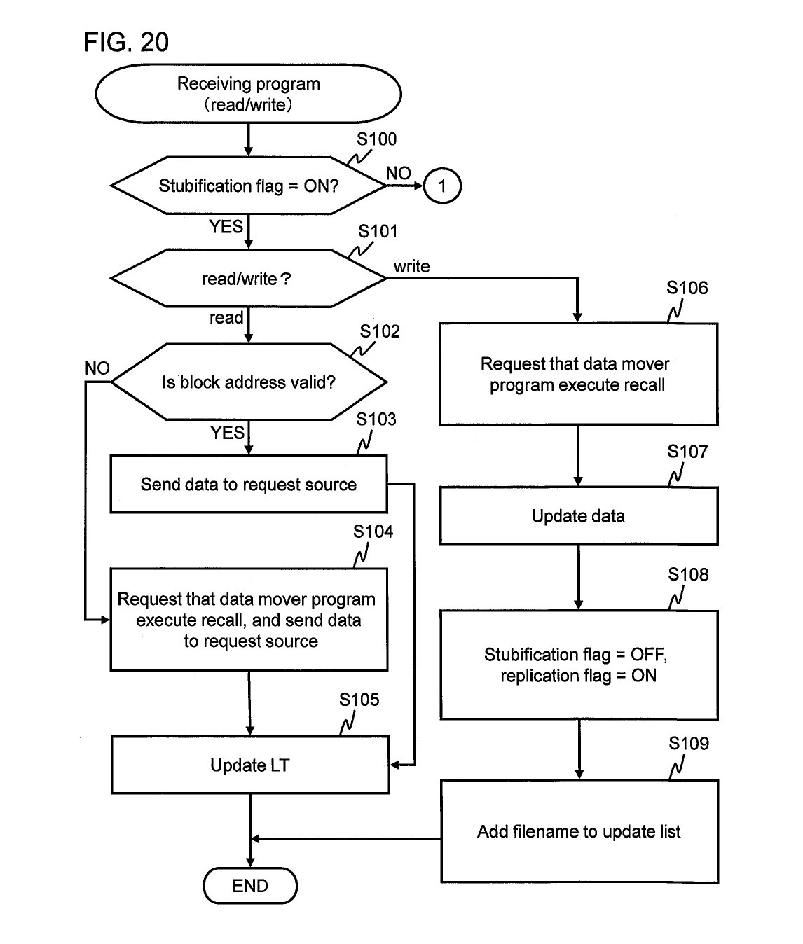

FIG. 20 is a flowchart showing a read request process and a write request process executed by the receiving program P104. The receiving program P104 boots up and executes the following processing upon receiving either a read request or a write request from the host 12.

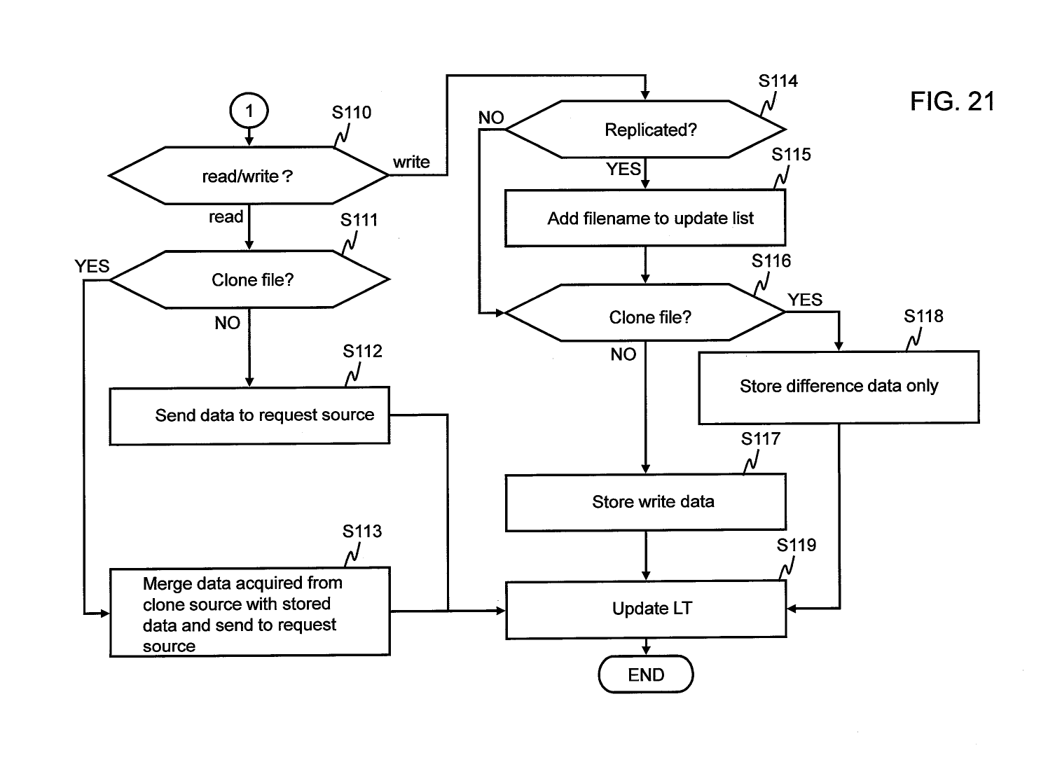

The receiving program P104 determines whether or not the stubification flag C106C of the target file requested by the host 12 is configured to ON (S100). In a case where the stubification flag is not configured to ON (S100: NO), the receiving program P104 moves to the processing of FIG. 21, which will be explained further below, because the target file has not been converted to a stubified file.

In a case where the stubification flag of the target file is configured to ON (S100: YES), the receiving program P104 decides whether the type of processing request from the host 12 is a read request or a write request (S101).

In the case of a read request (S101: read), the receiving program P104 references the inode management table T10 of the target file and determines whether the block address is valid (S102).

In a case where the block address is valid (S102: YES), the receiving program P104 reads the data of the target file and sends this data to the host 12, which is the request source (S103). In a case where the block address is valid, that is, a case in which the block address is configured to a value other than 0, the target file has not been converted to a stubified file. Therefore, a recall process is not necessary.

The receiving program P104 updates the value of the last access date/time C104 of the target file inode management table T10, and ends this processing (S105).

In a case where the target file block address is not valid (S102: NO), the receiving program P104 requests that the data mover program P101 execute a recall process (S104). The data mover program P101 executes the recall process.

The receiving program P104 sends the target file acquired from the archiving apparatus 20 to the host 12 (S104), updates the last access date/time C104 of the target file inode management table T10, and ends this processing (S105).

In a case where the processing request from the host 12 is a write request (S101: write), the receiving program P104 requests that the data mover program P101 execute a recall process (S106). The data mover program P101 executes the recall process in response to this request.

The receiving program P104 writes the write data to the target file acquired from the archiving apparatus 20, and updates the file data (S107). The receiving program P104 also updates the last access date/time C104 of the target file inode management table T10 (S107).

The receiving program P104 configures the stubification flag C106C of the file updated with the write data to OFF, and, in addition, configures the replication flag of this file to ON (S108). The receiving program P104 records the name of the file updated with the write data in the update list, and ends this processing (S109).

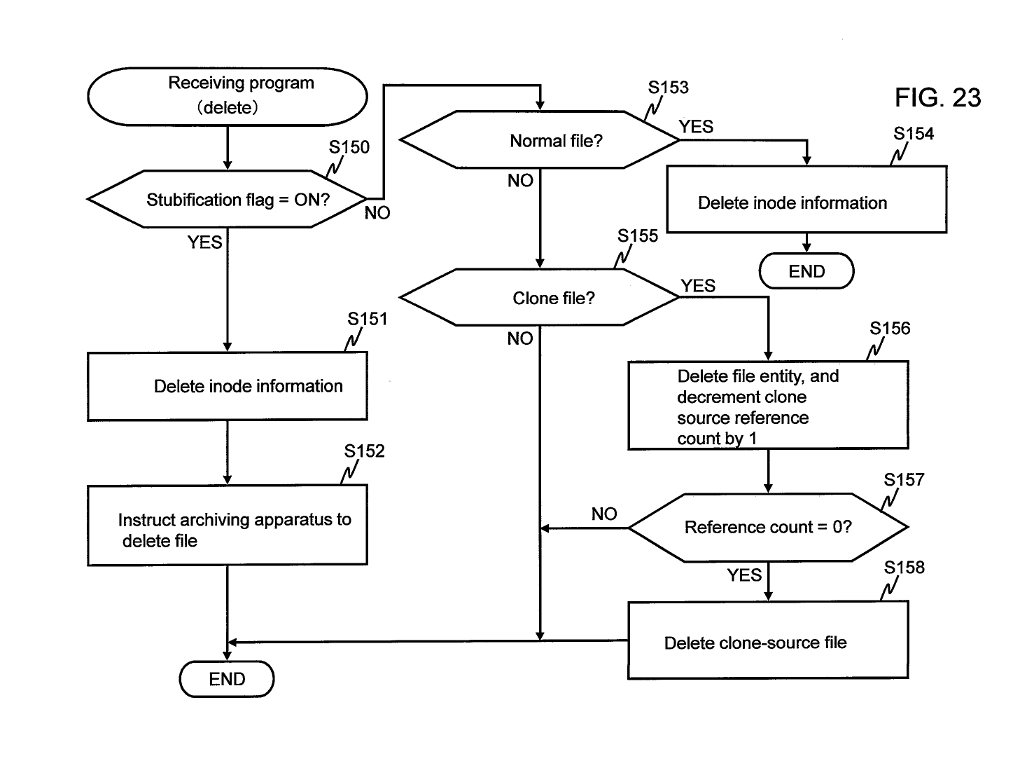

Refer to FIG. 21. In a case where OFF is configured in the stubification flag C106C of the processing-target file of the host 12 (S100: NO), the receiving program P104 moves to Step S110 of FIG. 23. The receiving program P104 determines whether the processing request from the host 12 is a read request or a write request (S110).

In the case of a read request (S110: read), the receiving program P104 determines whether the read-target file is a clone file (S111). In a case where the read-target file is not a clone file (S111: NO), the receiving program P104 reads data in accordance with the block address of the read-target file inode management table T10, and sends this data to the host 12 (S112). The receiving program P104 updates the last access date/time C104 of the read-target file (S119).

In a case where the read-target file is a clone file (S111: YES), the receiving program P104 merges data acquired from the clone-source file with the difference data stored in the read-target clone file, and sends this merged data to the host 12 (S113). The receiving program P104 updates the last access date/time C104 of the clone file, which is the read-target file (S119).

In a case where the processing request from the host 12 is a write request (S110: write), the receiving program P104 determines whether the write-target file is a replica (S114).

In a case where the write-target file is a replica (S114: YES), the receiving program P104 records the name of the write-target file in the update list (S115). This is because the write-data file is updated by the write data, and no longer matches the replica in the archiving apparatus 20. In a case where the write-target file is not a replica (S114: NO), the receiving program P104 skips Step S115 and moves to Step S116.

The receiving program P104 determined whether the write-target file is a clone file (S116). In a case where the write-target file in not a clone file (S116: NO), the receiving program P104 writes the write data to the write-target file based on the block address C107 of the write-target file (S117). The receiving program P104 updates the last access date/time C104 of the write-target file in which the write data was written (S119).

In a case where the write-target file is a clone file (S116: YES), the receiving program P104 writes the write data in accordance with the block address of the clone file (S118). The receiving program P104 only writes data with respect to the clone file without updating the data of the clone-source file. In accordance with this, the write-target clone file stores difference data, which differs from the data of the clone-source file (S118).

FIG. 23 is a flowchart showing copy processing executed by the receiving program P104. The receiving program P104 executes this processing upon receiving a copy request from the host 12.

The receiving program P104 determines whether the stubification flag C106C of the file specified as the copy source is configured to ON (S130). In a case where the stubification flag of the copy-source file is configured on ON (S130: YES), the receiving program P104 determines whether the block address of the copy-source file is valid (S131). There may be cases where a recall process has been completed in accordance with another access request even when the copy-source file has been converted to a stubified file.

In a case where the copy-source file block address is valid (S131: YES), the receiving program P104 acquires file data and metadata (the inode management table T10) in accordance with this block address (S132).

In a case where the copy-source file block address in not valid (S131: NO), the receiving program P104 requests that the data mover program P101 execute a recall process related to the data of the copy-source file (S133).

The receiving program P104, upon acquiring the file data and the metadata of the copy-source file, creates a copy of the copy-source file inside the primary volume 114 (S134). This copy file is a normal file (a non-clone file).

The receiving program P104 updates the last access date/time C104 of the copy-source file (S135). The receiving program P104 determines whether replication processing for the copy file created in Step S134 has ended (S136). In a case where the replication processing has ended (S136: YES), the receiving program P104 ends this processing.

In a case where the replication processing has not ended (S136: NO), the receiving program P104 requests that the data mover program P101 execute replication processing (S137).

In a case where the stubification flag C106C of the copy-source file is configured to OFF (S130: NO), the receiving program P104 determines whether or not the copy-source file is a clone file (S138).

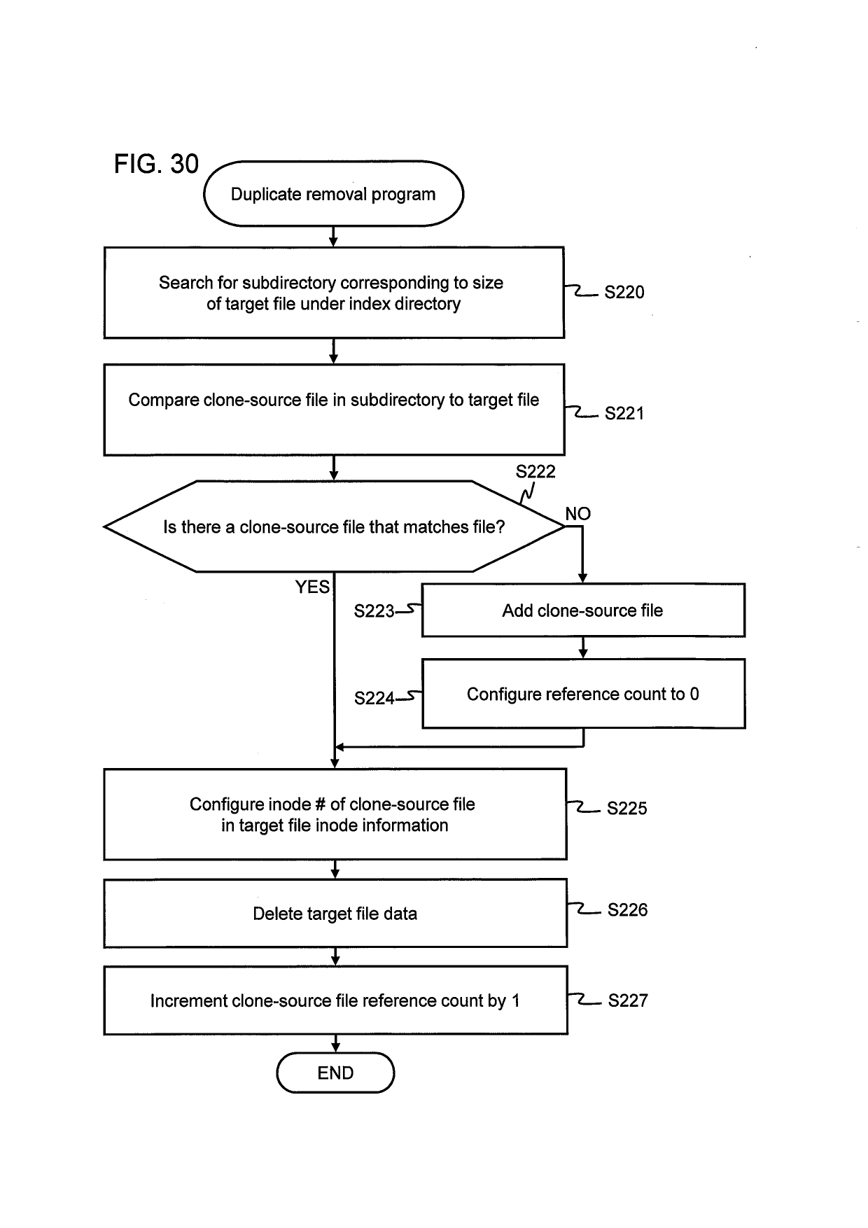

In a case where the copy-source file in not a clone file (S138: NO), the receiving program P104 invokes the duplicate removal program (FIG. 30), and converts the copy-source file to a clone file (S139). Files, which are not a clone files, include a clone-source file and a normal file, but the host 12 is unable to recognize and cannot directly access a clone-source file.

The receiving program P104 copies the information of the inode management table T10 of the copy-source file converted to a clone file, and creates a copy file of the copy-source file (S140). That is, the copy file is also created as a clone file.

The receiving program P104 increments by 1 the value of the reference count C106E of the clone-source file referenced by the copy-source file (S141). This is because a clone file was newly created in either Step S139 or Step S140.

The receiving program P104 updates the last access date/time C104 of the copy-source file (S135), and moves to Step S136. Explanations of the subsequent Steps S136 and S137 will be omitted.

FIG. 23 is a flowchart showing a delete process executed by the receiving program P104. The receiving program P104 executes this processing upon receiving a delete request from the host 12.

The receiving program P104 determines whether the stubification flag C106C of the delete-target file is configured to ON (S150). The receiving program P104, in a case where the stubification flag of the delete-target file is configured to ON (S150: YES), deletes the inode management table T10 of the delete-target file (S151). In addition, the receiving program P104 instructs the archiving apparatus 20 to delete the file, which is a replica of the delete-target file (S152), and ends this processing.

In a case where the stubification flag of the delete-target file is configured to OFF (S150: NO), the receiving program P104 determines whether the delete-target file is a non-clone file (S153). The non-clone file is a file other than a clone file, that is, a normal file. In a case where the delete-target file is a normal file (S153: YES), the receiving program P104 deletes the inode management table T10 of the delete-target file (S154) and ends the processing.

In a case where the delete-target file is not a normal file (S153: NO), the receiving program P104 determines whether the delete-target file is a clone file (S155). In a case where the delete-target file is not a clone file (S155: NO), the receiving program P104 ends the processing.

In a case where the delete-target file is a clone file (S155: YES), the receiving program P104 deletes the data (difference data) of the delete-target clone file, and, in addition, decrements by 1 the reference count C106E of the reference-destination clone-source file (S156).

The receiving program P104 determines whether the value of the clone-source file reference count C106E is 0 (S157). In a case where the reference count C106E value is not 0 (S157: NO), the receiving program P104 ends the processing.

In a case where the value of the clone-source file reference count C106E is 0 (S157: YES), the receiving program P104 deletes the file data and the metadata of the clone-source file (S158).

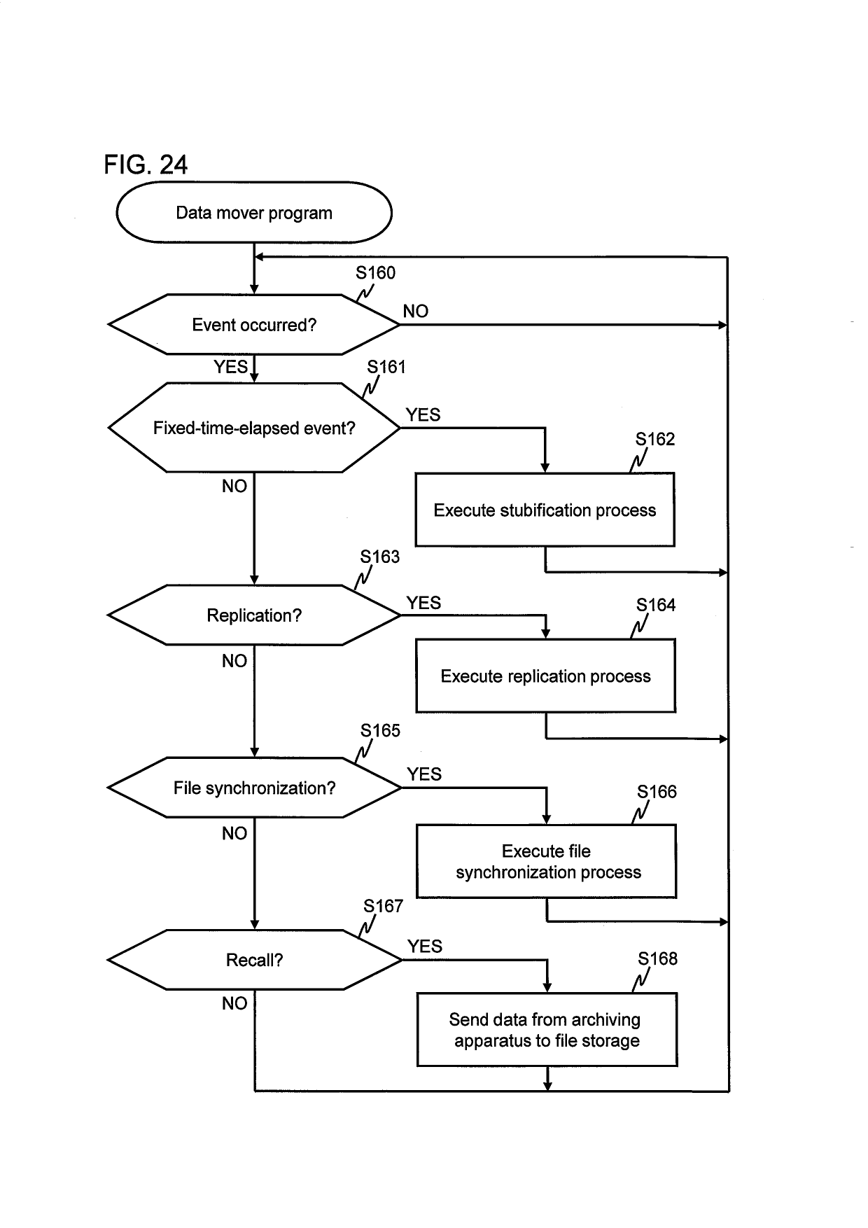

FIG. 24 is a flowchart showing the processing of the data mover program P101. This processing is event driven processing, which is started in accordance with the occurrence of an event.

The data mover program P101 determines whether any event of preconfigured prescribed events has occurred (S160). When an event occurs (S160: YES), the data mover program P101 determines whether an event denoting the passage of a defined time has occurred (S161).

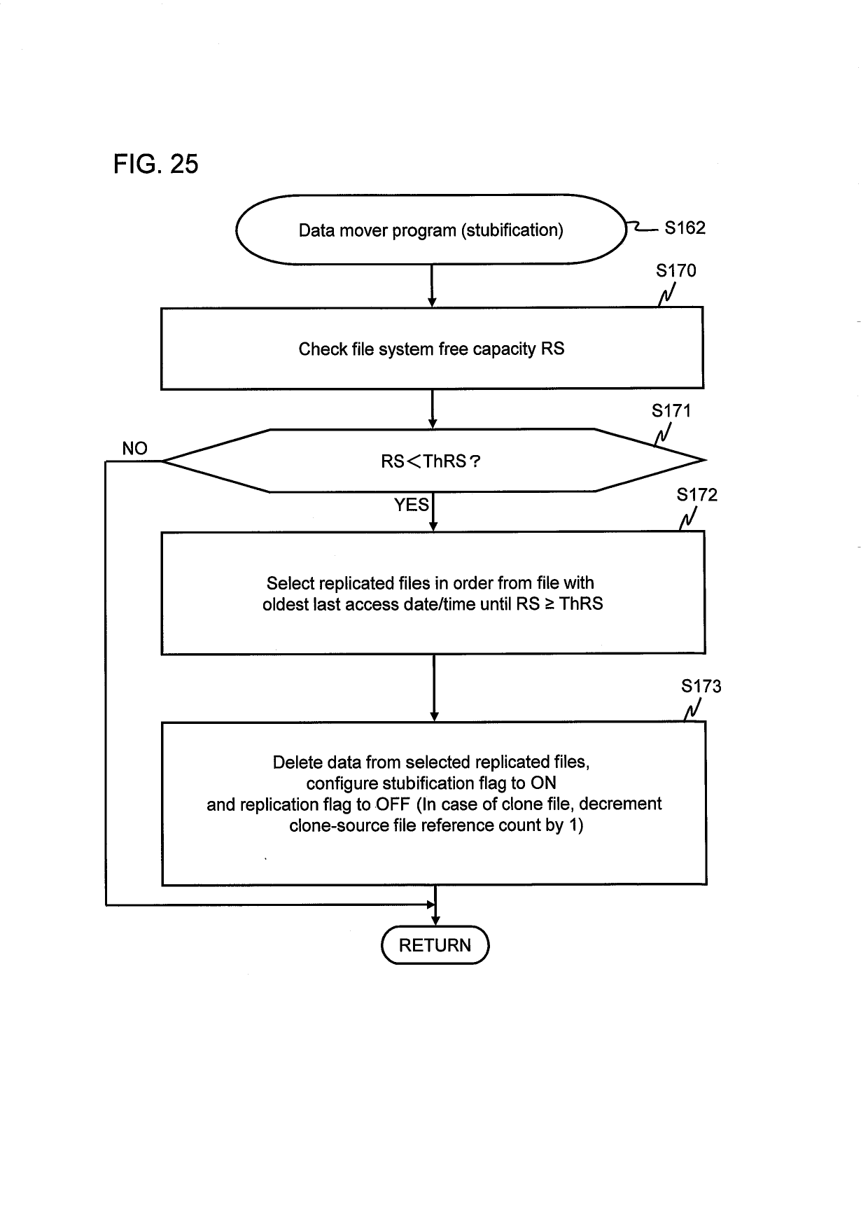

In a case where an event indicating the passage of a defined time has occurred (S161: YES), the data mover program P101 executes stubification processing (S162). The stubification process will be explained in detail further below using FIG. 25.

In a case where an event indicating the passage of a defined time has not occurred (S160: NO), the data mover program P101 determines whether it is an event requiring the execution of replication processing (S163). In a case where it is an event requiring the execution of replication processing (S163: YES), the data mover program P101 executes replication processing (S164). The replication process will be explained in detail further below using FIG. 26.

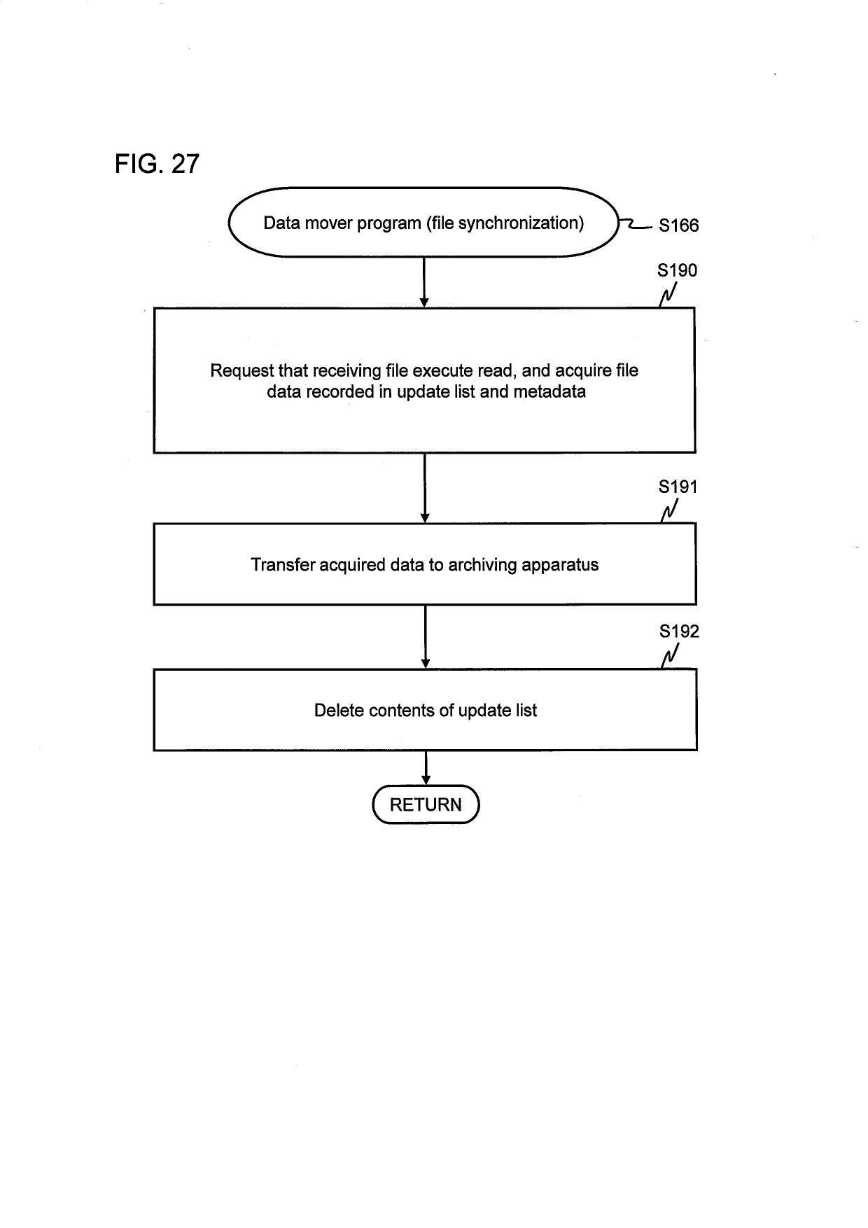

In a case where it is not an event requiring the execution of replication processing (S163: NO), the data mover program P101 determines whether it is an event requiring file synchronization (S165). In a case where it is an event requiring file synchronization (S165: YES), the data mover program P101 executes file synchronization processing (S166). The file synchronization process will be explained in detail further below using FIG. 27.

In a case where it is not an event requiring file synchronization (S165: NO), the data mover program P101 determines whether it is an event requiring the execution of recall processing (S167). In a case where it is an event requiring the execution of recall processing (S167: YES), the data mover program P101 acquires the file data from the archiving apparatus 20 and sends this file data to the file storage apparatus 10 (S168). Since the metadata has been left in the file storage apparatus 10, only the file data needs to be acquired from the archiving apparatus 20.

FIG. 25 is a flowchart showing the stubification process executed by the data mover program P101 in detail.

The data mover program P101 checks the free capacity RS of the file system of the file storage apparatus 10 (S170). The data mover program P101 determines whether the free capacity RS is smaller than a prescribed free capacity threshold ThRS (S171). In a case where the free capacity RS is equal to or larger than the threshold ThRS (S171: NO), the data mover program P101 ends this processing and returns to the processing of FIG. 24.

In a case where the free capacity RS is smaller than the threshold ThRS (S171: YES), the data mover program P101 selects replicated files in order from the file with the oldest last access date/time until the free capacity RS becomes equal to or larger than the threshold ThRS (S172).

The data mover program P101 deletes the data of the selected file, configures the stubification flag of this file to ON, and configures the replication flag of this file to OFF (S173). In accordance with this, the file selected in Step S172 is converted to a stubified file. In addition, in a case where a clone file is converted to a stubified file, the data mover program P101 decrements by 1 the value of the reference count C106E of the clone-source file referenced by this clone file (S173).

FIG. 26 is a flowchart showing the replication process executed by the data mover program P101 in detail.

The data mover program P101 acquires the replication file storage destination from the archiving apparatus 20 (S180). The data mover program P101 configures the acquired storage destination in the link destination C106D of the replication target inode management table T10 (S181).

The data mover program P101 issues a read request to the receiving program P104, and acquires a file, which is the target of replication processing (S182). The data mover program P101 transfers the replication-target file to the archiving apparatus 20 (S183). The data mover program P101 configures the replication flag C106B of the replication-target file to ON (S184).

FIG. 27 is a flowchart showing the file synchronization process executed by the data mover program P101.

The data mover program P101 issues a read request to the receiving program P104 and acquires the data and metadata of a file recorded in the update list (S190). The update list is information for identifying from among files for which replication processing has been completed a file, which was updated, and in which difference data occurred subsequent to replication processing. The update list is information for managing a file for which file synchronization processing will be performed.

The data mover program P101 transfers the acquired data to the archiving apparatus 20 (S191), and deletes the contents of the update list (S192).

FIG. 28 is a flowchart showing the operation of the selection program P105, which is part of the computer program for carrying out single instance processing.

The selection program P105 issues a read request to the receiving program P104 for each file managed by the file system (S200). The selection program P105 selects all files for which the last access date/time LT (the value recorded in column C104 of the inode management table T10) is older than a prescribed access date/time threshold ThLT (S200). The selection program P105 adds the name of the selected file to the single instance target list T11 (S200).

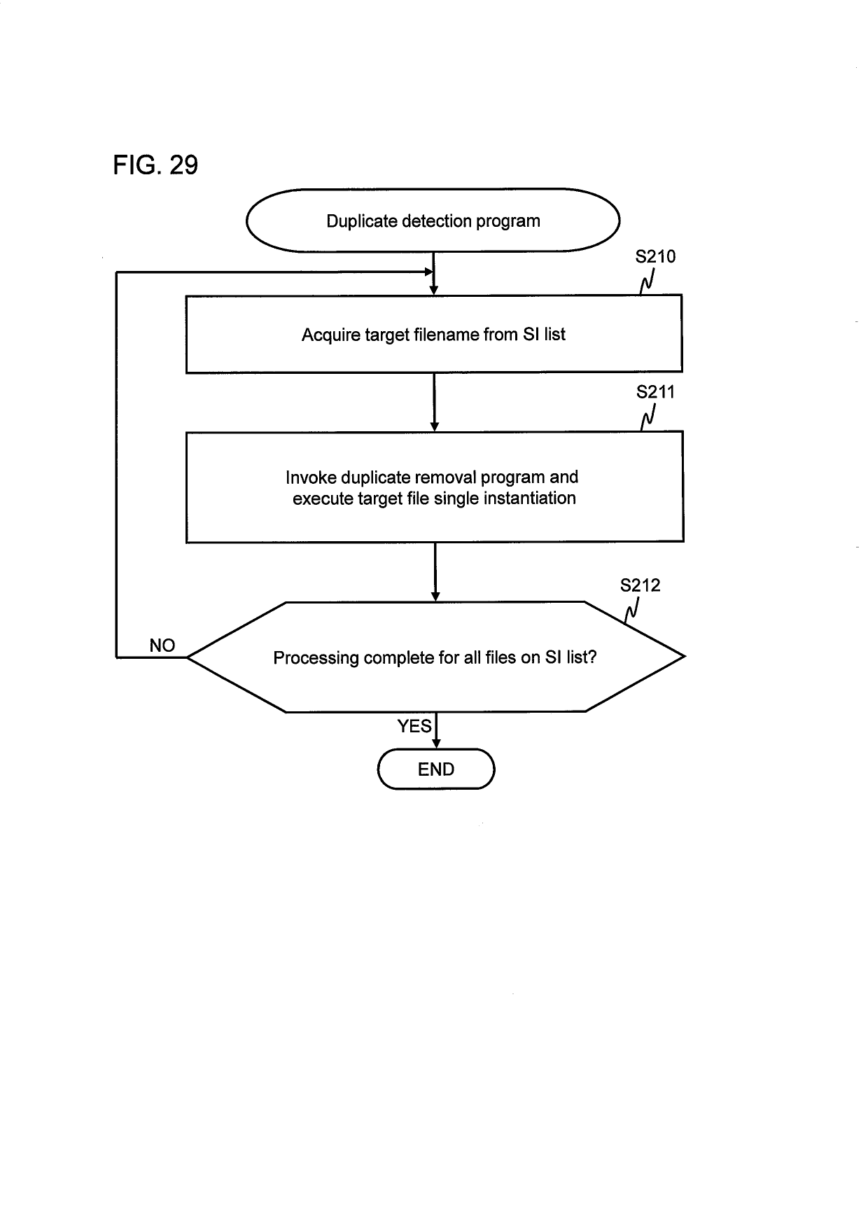

FIG. 29 is a flowchart showing the operation of the duplicate detection program P106, which, together with the selection program P105, is part of the computer program for executing single instance processing.

The duplicate detection program P106 acquires a target filename from the single instance target list T11 (S210). The duplicate detection program P106 invokes the duplicate removal program (FIG. 30), and executes a single instantiation of the target file (creates a clone file) (S211). The duplicate detection program P106 executes Steps S210 and S211 until single instance processing has been applied to all the files recorded in the list T11 (S212).

FIG. 30 is a flowchart showing the operation of the duplicate removal program. The duplicate removal program searches the subdirectories under the index directory (FIG. 9) for the subdirectory corresponding to the size of the target file (S220).

The duplicate removal program compares the target file to the clone-source files in the subdirectory (S221), and determines whether there is a clone-source file, which matches the target file (S222).

In a case where none of the existing clone-source files in the search-target subdirectory matches the target file (S222: NO), the duplicate removal program adds a new clone-source file (S223).

That is, the duplicate removal program adds a target file to the search-target subdirectory as a new clone-source file. The duplicate removal program configures “0” in the reference count C106E of the newly created clone-source file (S224).

The duplicate removal program configures the clone-source file mode number in the target file reference-destination mode number C106A (S225). The duplicate removal program deletes the data of the target file (S226), and increments by 1 the value of the clone-source file reference count C106E (S227).

According to this example, which is configured in this fashion, the storage area (the file system area) of the file storage apparatus 10 can be used efficiently. For this reason, more numerous files can be stored in the file storage apparatus 10, increasing responsiveness at access time, and, in addition, enhancing user usability.

In this example, since the clone-source file is not targeted for replication processing, the stubification process, which is a prerequisite for executing replication processing, is also not applied to the clone-source file. Therefore, it is possible to prevent the clone-source file, which cannot be directly accessed by the user, from being converted to a stubified file because it appears to have a low utilization frequency. As a result of this, it is possible to maintain the response performance of a clone file, which references the clone-source file.

In this example, in a case where a file copy request has been received, a copy file is created as a clone file. For this reason, the file data need not be copied, enabling the storage area of the file storage apparatus 10 to be used effectively.

In this example, in a case where a file copy request has been received and a clone-source file matching the copy-target file does not exist, a new clone-source file, which matches the copy-target file, is created, and the copy-target file is converted to a clone file. Therefore, single instance processing can be applied quickly, the time during which duplicate data exists can be shortened, and the storage area of the file storage apparatus 10 can be used effectively. That is, duplicate data can be removed immediately at the point in time of a file copy prior to single instance processing being executed on a normal cycle.

In this example, each time a clone file, which references a clone-source file, is created, the value of the reference count C106E of the clone-source file is incremented by 1. Then, in this example, each time a clone file is deleted or converted to a stubified file, the value of the reference count C106E is decremented by 1, and when the reference count C106E value reaches 0, the clone-source file is deleted. Therefore, the clone-source file can be sustained as long as there is a clone file, which references the clone-source file, making it possible to maintain clone file response performance. In addition, since the clone-source file is deleted in a case where there are no clone files referencing the clone-source file, the storage area of the file storage apparatus 10 can be used effectively.

In this example, the clone file is stored in the archiving apparatus 20 in a state in which both data (difference data) unique to the clone file and data referenced from the clone-source file data is stored. That is, the clone file stored in the archiving apparatus 20 stores all the data. Therefore, in a case where either a clone file or a clone-source file being stored in the file storage apparatus 10 should be damaged, a complete clone file can be written back to the file storage apparatus 10 from the archiving apparatus 20.

In this example, the clone-source file is stored in a special directory (the index directory), which is not visible to the user. This makes it possible to protect the clone-source file from user error, and to enhance the reliability of the hierarchical storage system.

In this example, a subdirectory is disposed by file-size ranking in the index directory, and a clone-source file is managed inside a subdirectory of a corresponding file size. Therefore, the search range for a clone-source file can be narrowed on the basis of the size of the target file, enabling a clone-source file matching the target file to be retrieved at high speed.

### Example 2

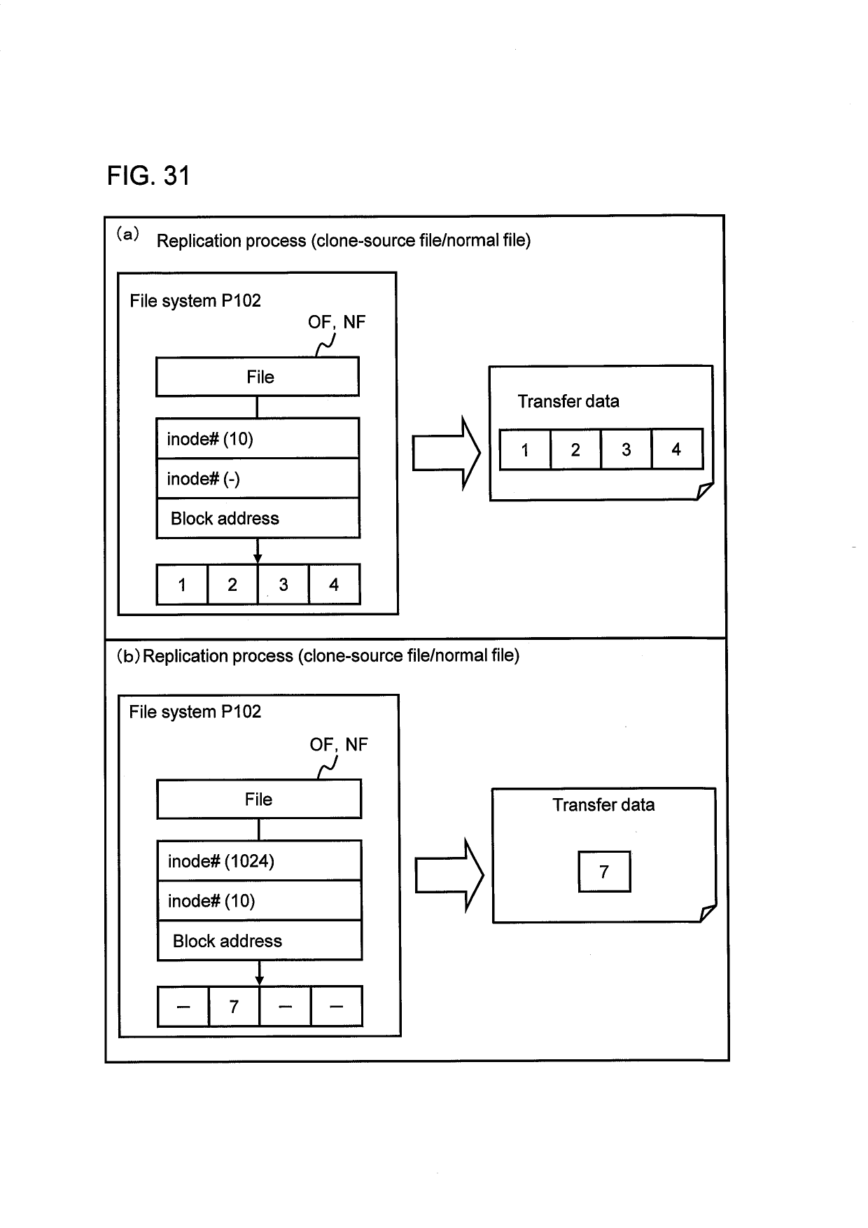

A second example will be explained by referring to FIGS. 31 through 38. This example is a variation of the first example. Therefore, the explanation will focus on the differences with the first example. In this example, a clone-source file is a target for replication processing and stubification processing on the archiving apparatus 20 side as well. In this example, the last access date/time of a clone-source file is appropriately evaluated, and the conversion of a referenced clone-source file to a stubified file is prevented.

FIG. 31 shows data being transferred using the replication process of this example. FIG. 31(a) shows the case of a clone-source file and a normal file. In a case where replicas of a clone-source file and a normal file (a non-clone file) are created in the archiving apparatus 20, all the file data is transferred from the file storage apparatus 10 to the archiving apparatus 20.

Alternatively, in the case of a clone file, as shown in FIG. 31(b), only the data (difference data with the clone-source file) unique to the clone file is transferred from the file storage apparatus 10 to the archiving apparatus 20.

In the archiving apparatus 20, a replicated clone file references either part or all of the data in a replicated clone-source file the same as in the file storage apparatus 10.

In the first example, the clone file is transferred to the archiving apparatus 20 in a state in which all data is stored. Therefore, not only is duplicate data transferred and the communication network congested, the storage area of the archiving apparatus 20 is used wastefully.

Alternatively, in this example, only the difference data of the clone file is transferred from the file storage apparatus 10 to the archiving apparatus 20 as shown in FIG. 31. This makes it possible to inhibit the transfer of duplicate data, and to use the storage area of the archiving apparatus 20 efficiently.

However, in this example, since the clone-source file is also treated as a replication processing target, there is the likelihood of the clone-source file being converted to a stubified file before the clone file. As described hereinabove, the clone-source file is the file that serves as the reference, and is managed using a special directory to prevent it being destroyed or removed due to error.

Therefore, even when a clone file, which references the clone-source file, is used frequently, this does not affect the utilization frequency of the clone-source file, which stores the data being referenced. As a result of this, the clone-source file, which is being referenced, is converted to a stubified file prior to the clone file, which is doing the referencing. Since a recall process must be carried out when a stubified clone-source file is referenced, the response performance of the clone file decreases and the user usability worsens.

Consequently, in this example, the last access date/time of the clone-source file is calculated on the basis of the last access date/time of the clone file. The following methods, for example, will be considered as methods for calculating the last access date/time of the clone-source file based on the last access date/time of the clone file.

A first method is a method in which the most recent last access date/time of the respective last access dates/times of multiple clone files, which are referencing the same clone-source file, is used as the last access date/time of the clone-source file.

A second method is a method for calculating either a weighted or unweighted average value of the respective last access dates/times of multiple clone files, which are referencing the same clone-source file.

The relative merits of the two methods described hereinabove will be considered. In the case of the first method, there could be cases in which the clone file comprising the most recent last access date/time of the multiple clone files is merely referencing the clone-source file as a matter of form, and does not actually possess data, which is being shared with the clone-source file. Determining the last access date/time of the clone-source file in accordance with the last access date/time of a clone file, which is substantially unrelated to the clone-source file, is believed to be inappropriate and undesirable.

In addition, in the case of the first method, for example, when the last access date/time of only one clone file is new and only this one new last access date/time is used despite the fact that the last access dates/times of the large majority of the clone files of the multiple clone files are old, there is the likelihood of this last access date/time being far removed from the actual situation. The fact that only one clone file is being used despite the fact that most of the clone files are hardly being used at all should be seen, from a majority decision standpoint, as the end of the role of the clone-source file.

Therefore, in this example, the second method is used, an average value of the last access dates/times of the multiple clone files is calculated, and this average value is configured as the last access date/time of the clone-source file. Unless omitted from the claims, the first method is also included within the scope of the present invention.

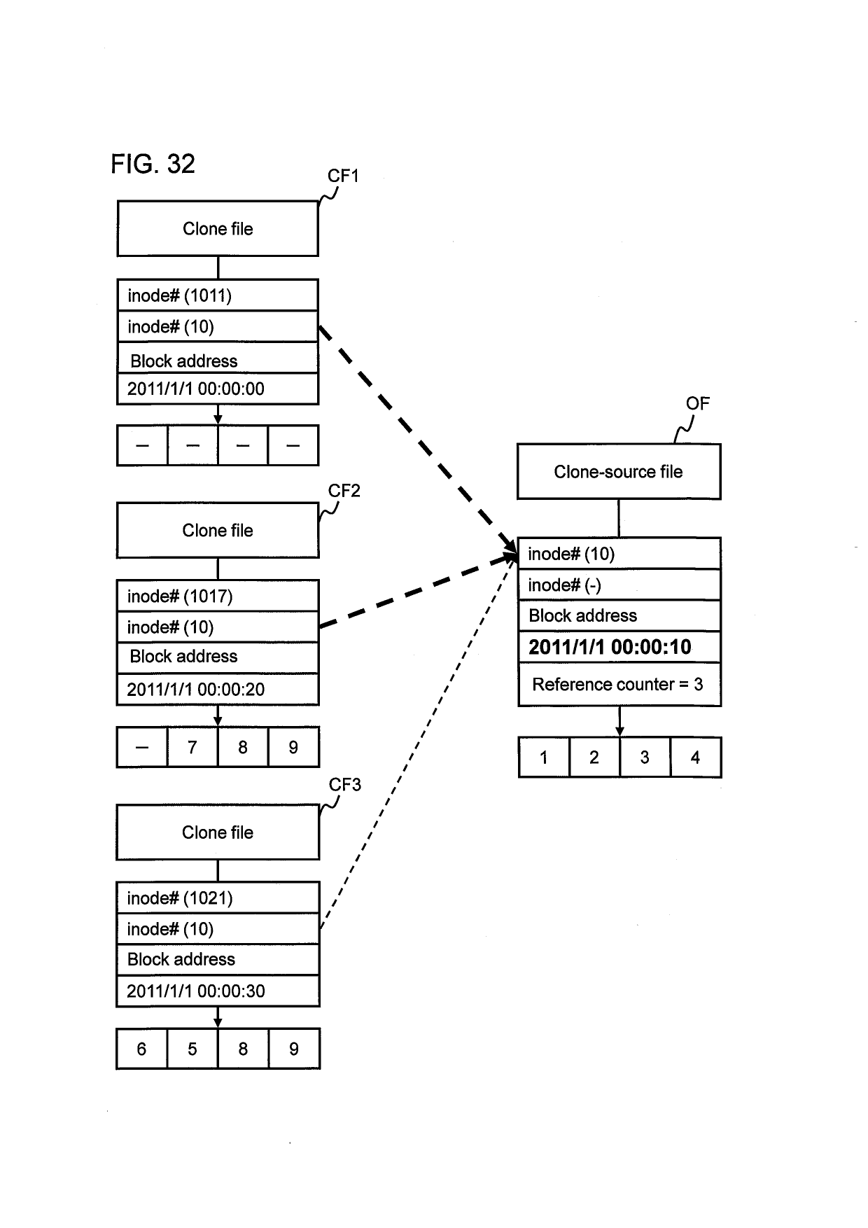

FIG. 32 is an illustration showing a method (the second method) for calculating the last access date/time of the clone-source file.

FIG. 32 shows three clone files CF1, CF2, CF3, which reference the clone-source file. The data of clone file CF1 completely matches the data of the clone-source file. The data of clone file CF2 mostly matches the data of the clone-source file, but differs in part. The data of the clone file CF3 does not match the data of the clone-source file at all.

In accordance with this, the average value ALT of the last access dates/times of the clone files is calculated based on the last access date/time LT1 of the clone file CF1 and the last access date/time LT2 of the clone file CF2 (ALT=(LT1+LT2). This average value ALT is configured in the last access date/time C104 of the clone-source file.

The last access date/time LT3 of the clone file CF3, which has absolutely nothing in common with the data of the clone-source file, is excluded when calculating the average value ALT in order to calculate a last access date/time that most closely approximates the actual situation by eliminating the clone file, which is unrelated to the clone-source file.

In other words, eliminating the clone file with completely incompatible data refers to weighting the clone files in accordance with the extent of compatible data and calculating the average value of the last access dates/times.

That is, the last access dates/times LT1 and LT2 of the data-compatible clone files CF1 and CF2 are used by multiplying these last access dates/times LT1 and LT2 by a coefficient W1 (for example, 1), and the last access date/time LT3 of the data-incompatible clone file CF3 is used by multiplying this last access date/time LT3 by a coefficient W2 (for example, 0). This makes it possible to find the average value ALT of the last access dates/times using ALT=(LT1×W1+LT2×W1+LT3×W2)/3). The weighted coefficient W1 may be configured to a value other than 1 when the value is equal to or larger than 0. The weighted coefficient W2 may be configured to a value at at least 0 when the value is smaller than W1. The value of the weighting coefficient W may be configured in accordance with the rate at which the clone-source file data is referenced. However, the average value ALT must ultimately be adjusted so as not to be far removed from the last access dates/times LT of the respective clone files.

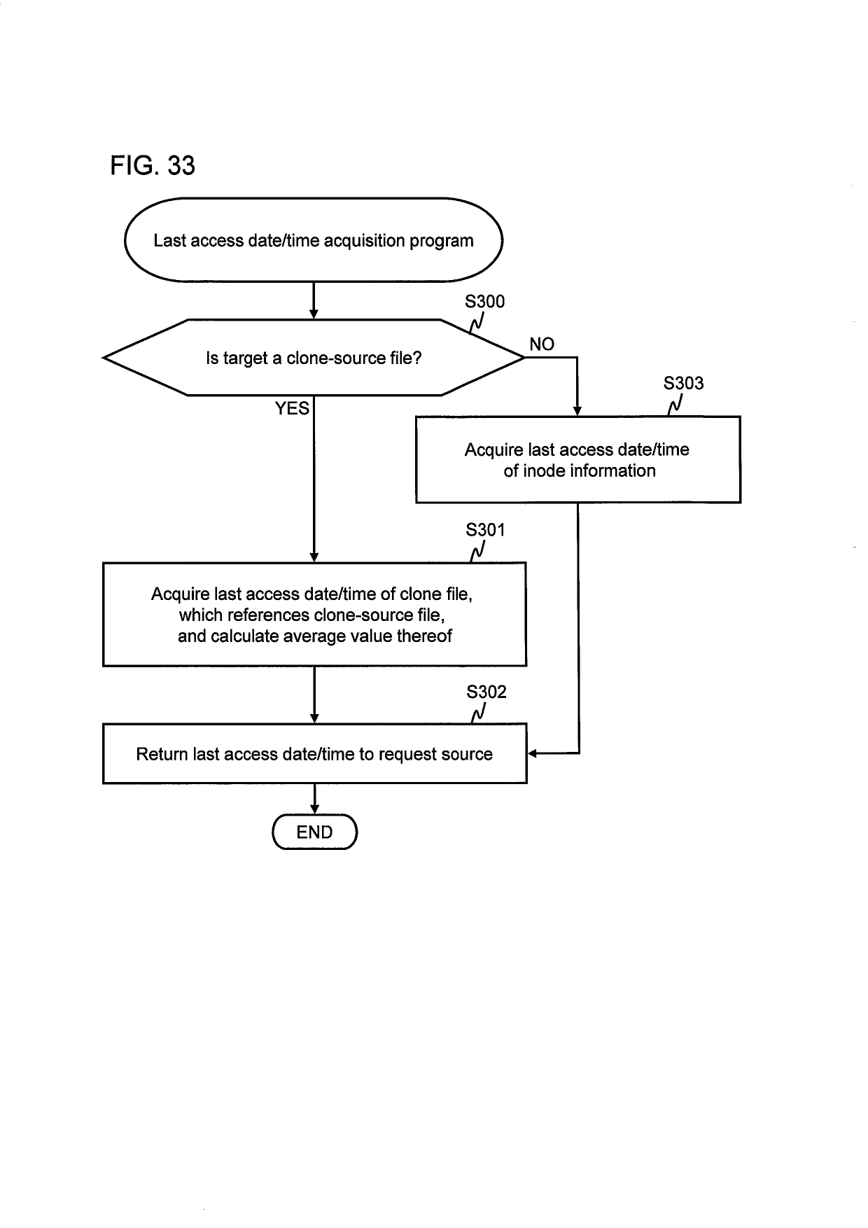

FIG. 33 is a flowchart showing the operation of a program for acquiring a last access date/time. The last access date/time acquisition program (hereinafter, the LT acquisition program) is invoked by the receiving program P104. The LT acquisition program is boot up in a case where a process requiring a last access date/time is executed.

First of all, the LT acquisition program determines whether the target file is a clone-source file (S300). In a case where the target file is a clone-source file (S300: YES), the LT acquisition program acquires the last access dates/times from the clone files, which are referencing the clone-source file, and calculates the average value thereof as was described using FIG. 32 (S301). The LT acquisition program returns to the receiving program P104, which is the request source, the calculated average value as the last access date/time of the clone-source file (S302), and ends the processing.

In a case where the target file is not a clone-source file (S300: NO), the LT acquisition program acquires a value from the last access date/time column C104 of the inode management table T10 (S303). The LT acquisition program returns the acquired last access date/time to the receiving program P104 (S302) and ends the processing.

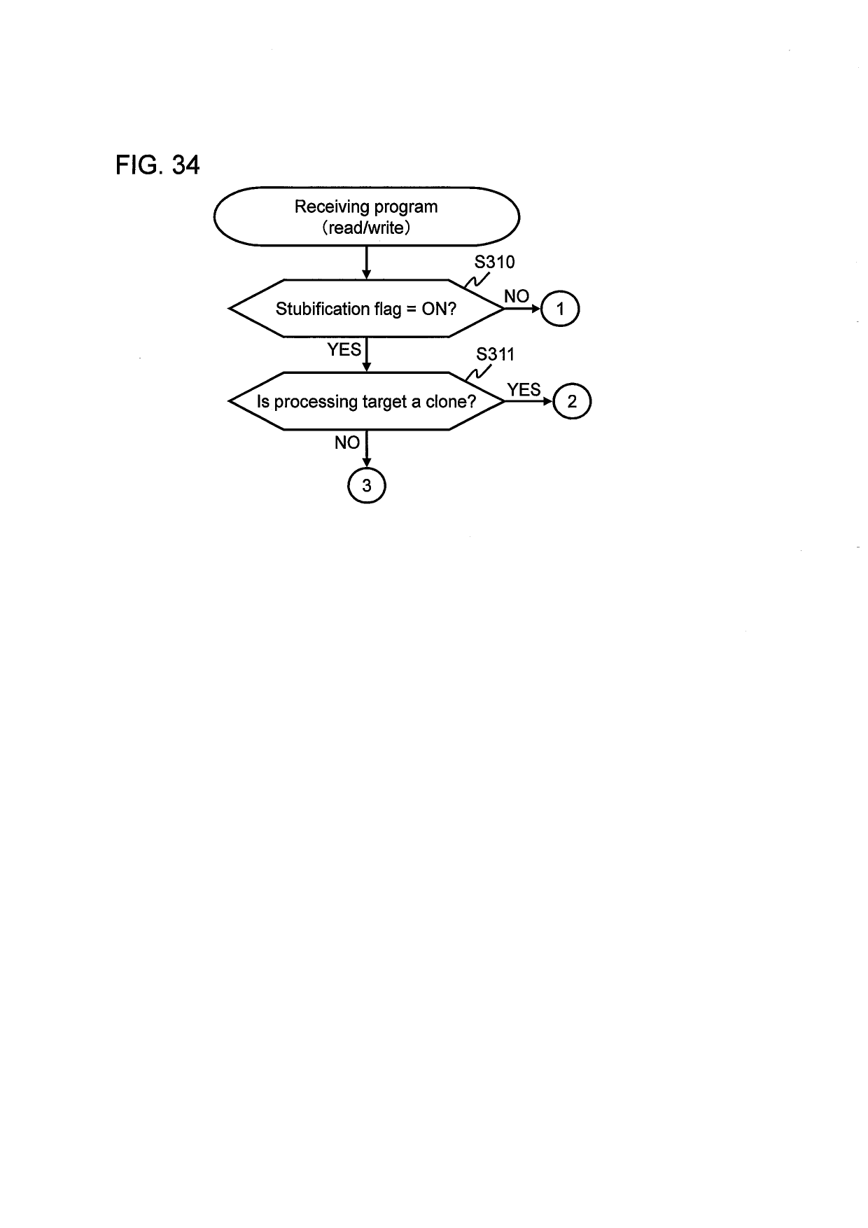

FIG. 34 is a flowchart showing a read request process and a write request process executed by the receiving program P104.

The receiving program P104, upon receiving a processing request from the host 12, determines whether ON is configured in the stubification flag of the target file (S310). In a case where the stubification flag is configured to OFF (S310: NO), the receiving program P104 moves to the processing described in FIG. 21.

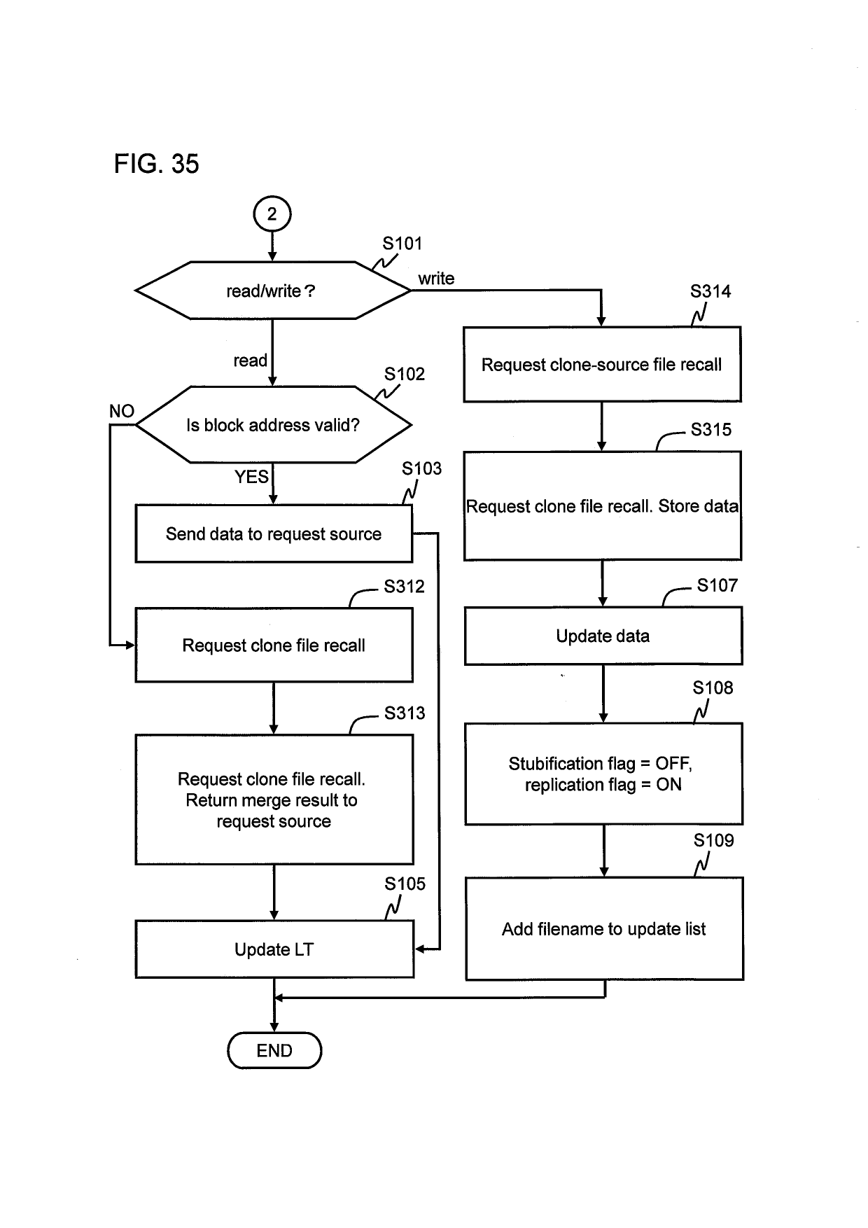

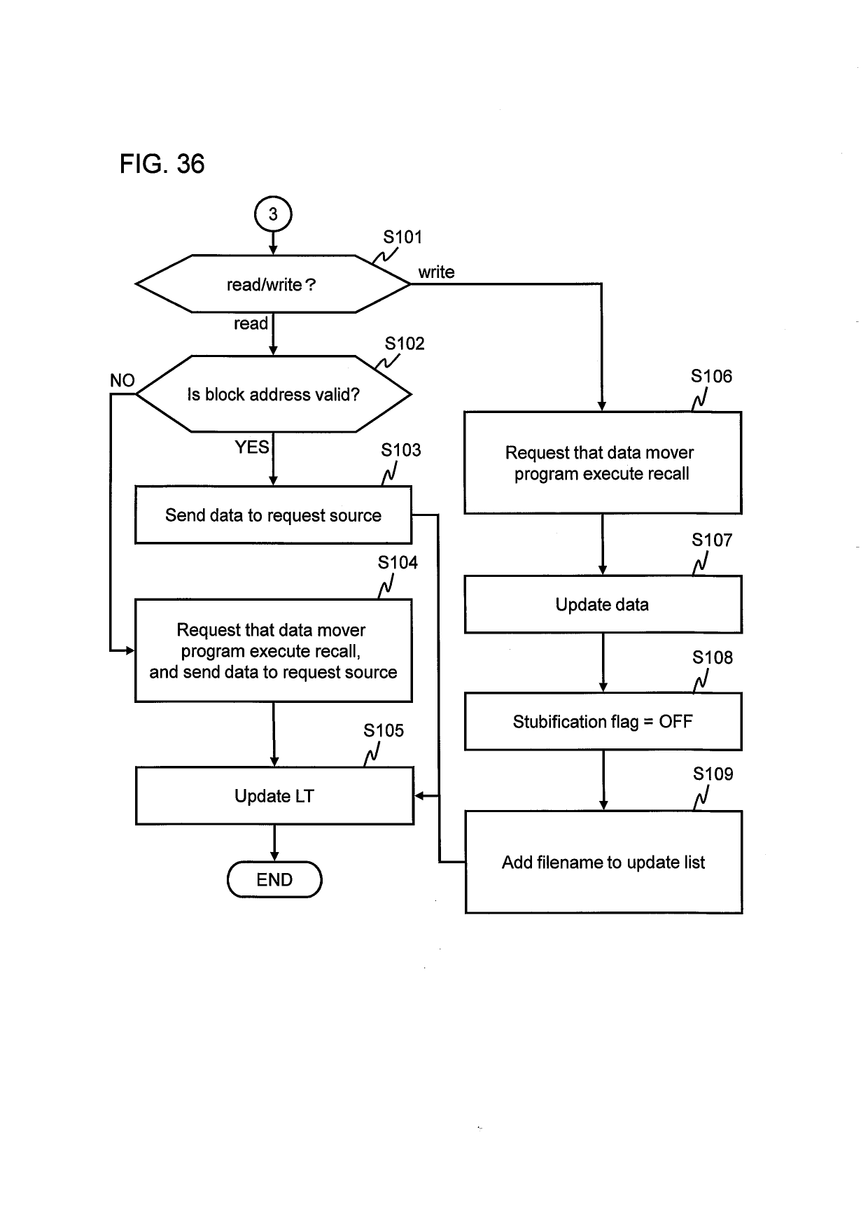

In a case where the stubification flag is configured to ON (S310: YES), the receiving program P104 determines whether the target file is a clone file (S311). In a case where the target file is a clone file (S311: YES), the receiving program P104 moves to the processing of FIG. 35. In a case where the target file is not a clone file (S311: NO), the receiving program P104 moves to the processing of FIG. 36.

FIG. 35 is the processing in a case where the target file is a clone file. The processing shown in FIG. 35 comprises Steps S101, S102, S103, S105, S107, S108 and S109 of the processing shown in FIG. 20, but does not comprise Steps S104 and S106 of FIG. 20.

In this example, since the clone-source file may also be converted to a stubified file, in the processing shown in FIG. 35, new Steps S312 and S313 are executed in place of Step S104, and new Steps S314 and S315 are executed in place of Step S106.

In the case of a read request (S101: read), the receiving program P104 determines whether the block address of the target file is valid (S102). In a case where the block address is not valid (S102: NO), the receiving program P104 requests a recall with respect to the data of the clone-source file being referenced by the clone file, which is the target file (S312). The receiving program P104 also requests a recall with respect to the data of the clone file, which is the target file, merges the clone-source file data with the clone file date, and returns the result to the request source (S313).

Alternatively, in the case of a write request (S101: write), the receiving program P104 requests a recall with respect to the data of the clone-source file being referenced by the clone file, which is the target file (S314). The receiving program P104 also requests a recall with respect to the data of the clone file, which is the target file (S315). Thereafter, the receiving program P104 overwrites the data of the clone file, which is the target file, with the write data (S107).

FIG. 36 is a flowchart showing processing in a case where the target file in the processing of FIG. 34 is not a clone file. Since this processing comprises only the Steps S101 through S109 described using FIG. 20, an explanation will be omitted.

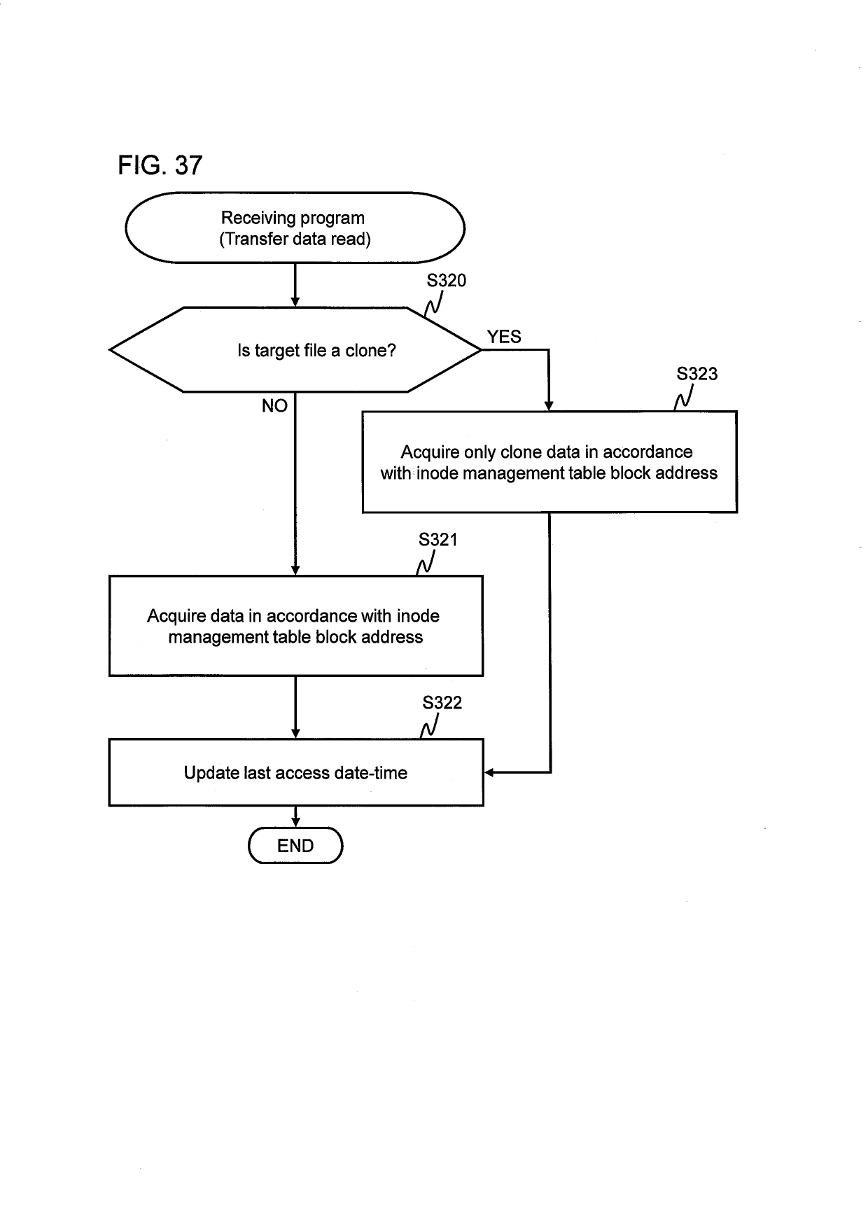

FIG. 37 is a flowchart showing processing for reading data from the file storage apparatus 10 for transfer to the archiving apparatus 20 for either a replication process or a file synchronization process.

First, the receiving program P104 determines whether the target file is a clone file (S320). In a case where the target file is not a clone file (S320: NO), the receiving program P104 acquires data in accordance with the block address of the inode management table T10, and returns this data to the request source (S321). The receiving program P104 updates the last access date/time C104 of the target file (S322) and ends the processing.

In a case where the target file is a clone file (S320: YES), the receiving program P104 acquires the data unique to the clone file (difference data) in accordance with the block address of the inode management table T10, and returns this data to the request source (S323).

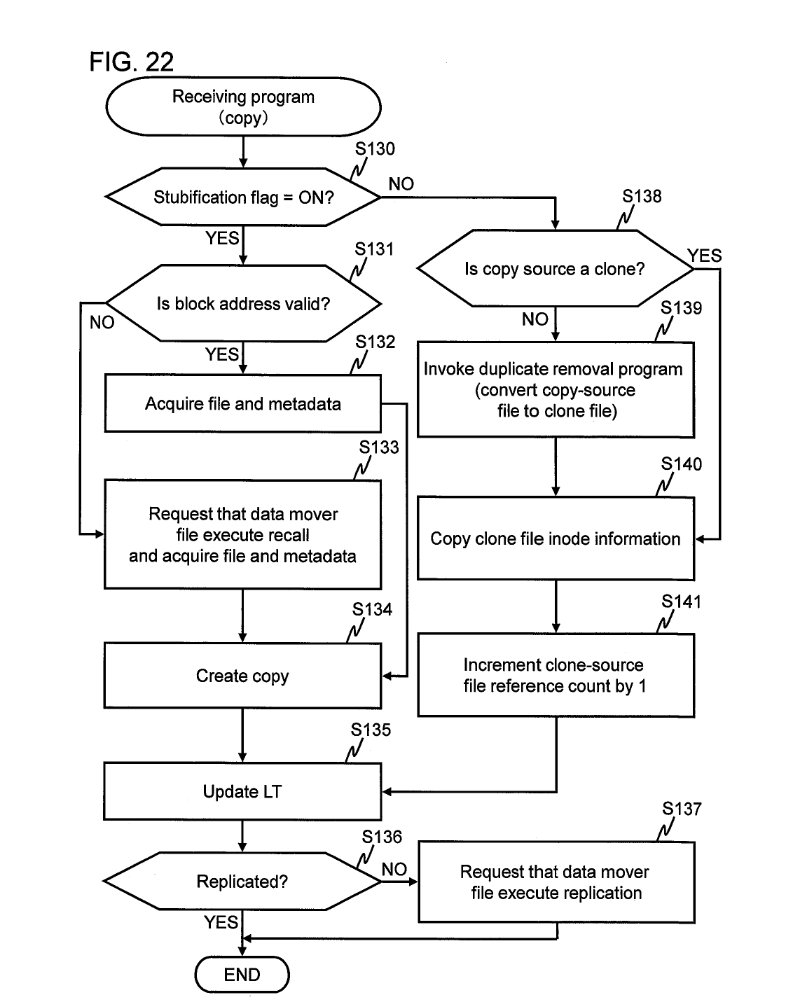

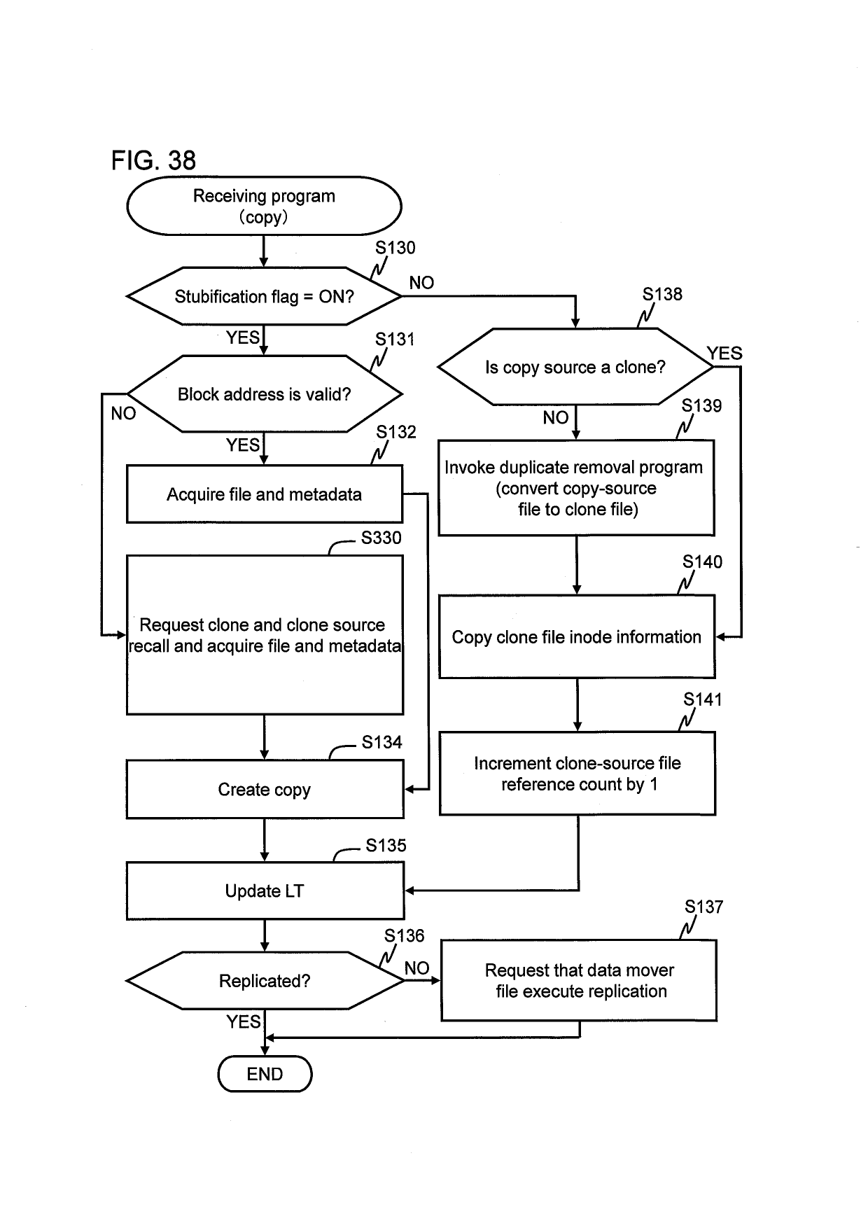

FIG. 38 is a flowchart showing a file copy process executed by the receiving program P104. In comparison to the processing described using FIG. 22, this processing comprises a new Step S330 in place of Step S133.

In a case where the block address of the copy-target file is not valid (S131: NO), the receiving program P104 requests a recall with respect to the clone-source file and the clone file, and acquires the file data and the metadata (S330).

Configuring this example like this achieves the same effects as the first example. In addition, in this example, the clone-source file is also the target of replication processing, and a single instance relationship is maintained on the archiving apparatus 20 side as well. Therefore, in this example, only the unique data of the clone file needs to be transferred to the archiving apparatus 20, making it possible to reduce the data transfer size from the file storage apparatus 10 to the archiving apparatus 20. It is also possible to make efficient use of the storage area of the archiving apparatus 20.

In this example, the last access date/time of the clone-source file is calculated based on the last access date/time of the clone file (for example, an average value is found). Therefore, it is possible to inhibit the clone-source file being referenced by the clone file from being converted to a stubified file ahead of the clone file. This prevents a drop in clone file response performance.

### Example 3

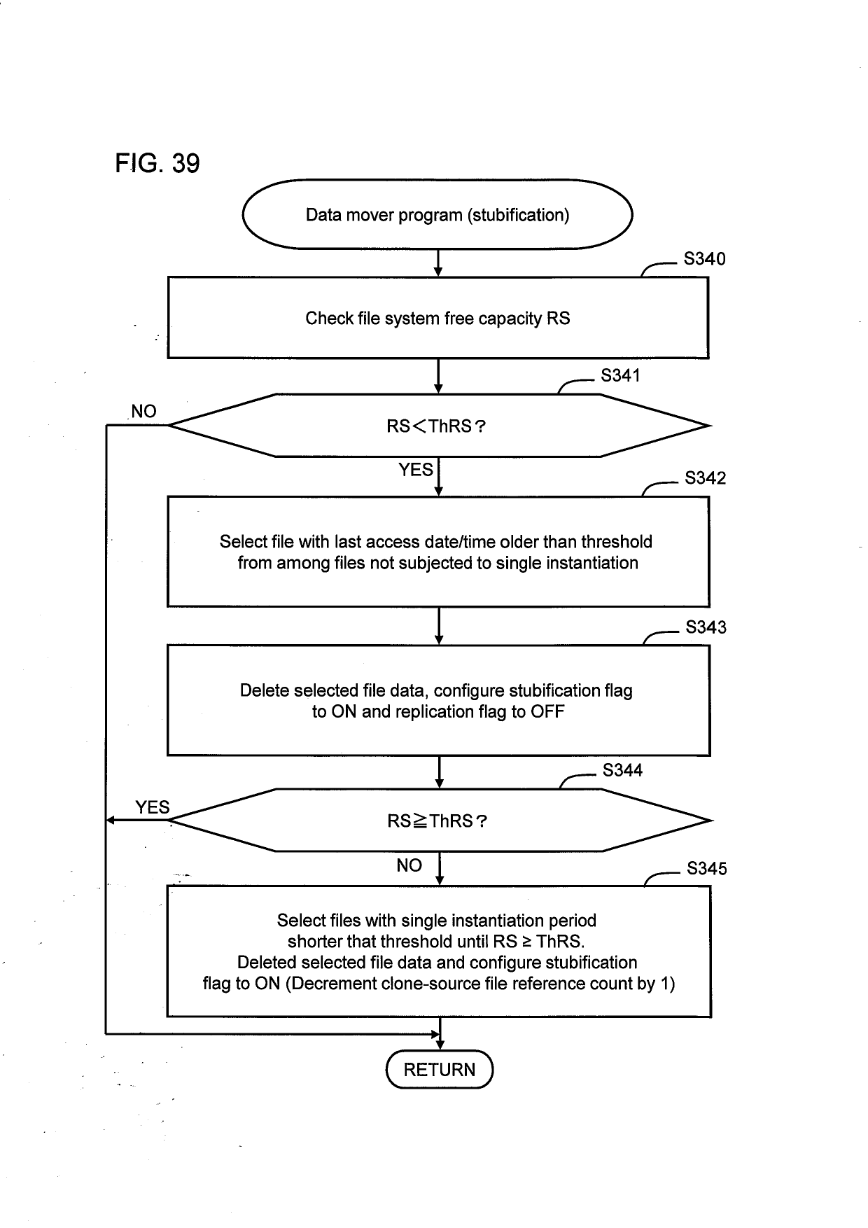

FIG. 39 is a flowchart showing the operation of a stubification process during the operation of a data mover program P101 of a third example.

The data mover program P101 checks the free capacity RS of the file system (S340), and determines whether this free capacity RS is smaller than a prescribed threshold ThRS (S341). In a case where the free capacity RS is equal to or larger than the threshold ThRS (S341: NO), the data mover program P101 ends this processing.

In a case where the free capacity RS is smaller than the threshold ThRS (S341: YES), the data mover program P101 issues a read request to the receiving program P104, and acquires the last access date/time of each file (S342). The data mover program P101 selects a file for which the last access date/time is older than a prescribed threshold from among the files (non-clone files), which have not undergone single instantiation (S342).

The data mover program P101 deletes the data of the file selected in Step S342, configures the stubification flag C106C of this file to ON, and, in addition, configures the replication flag C106B of this file to OFF (S343).

The data mover program P101 rechecks the free capacity RS of the file system and determines whether the free capacity RS has become equal to or larger than the threshold ThRS (S344). In a case where the free capacity RS has become equal to or larger than the threshold ThRS (S344: YES), the data mover program P101 ends this processing.

In a case where the free capacity RS does not become equal to or larger than the threshold ThRS even though the non-clone file has been converted to a stubified file (S344: NO), the data mover program P101 selects a single-instantiated file (a clone file), and converts this clone file to a stubified file (S345).

The data mover program P101 selects from among the clone files a clone file for which the single instantiation period SIT is shorter than a prescribed threshold ThSIT until the free capacity RS becomes equal to or larger than the threshold ThRS (S345). The data mover program P101 deletes the data of the selected file, and configures the stubification flag of this file to ON (S345). The data mover program P101 also decrements by 1 the value of the reference count C106E of the clone-source file (S345).

Configuring this example like this makes it possible to combine this example with both the first example and the second example, and this example achieves the same effects as either the first example or the second example.

In this example, when executing the stubification process, first of all, the non-clone file is converted to a stubified file (S342, S343), and when this is not enough, the clone file is converted to a stubified file (S345). In addition, in this example, the stubification process is carried out beginning with the clone file for which the period of being a clone file (the single instantiation period) is the shortest of the clone files.

A stubification file candidate comprises the following two types of files. The first type is a file, which underwent single instantiation at the point in time of file creation. That is, a file, which was converted to a clone file on the explicit instructions of the user at file creation time. The second type is a file, which has just recently been converted to a clone file in accordance with the cyclical implementation of single instance processing.

The first type of clone file is a clone file from the time of file creation, and as such, has been contributing to reducing the stored capacity for a relatively long time. Alternatively, the second type of clone file was converted to a clone file recently, and contributes little to reducing the stored capacity.

Consequently, in this example, user usability is enhanced by leaving the first type of clone file in the file storage apparatus 10 as much as possible. For this reason, the second type of clone file is converted to a stubified file after first converting the non-clone file to a stubified file.

The present invention is not limited to the respective examples described hereinabove. A person with ordinary skill in the art will be able to make various additions and changes without departing from the scope of the present invention. For example, the technical features of the present invention described above can be put into practice by combining these features as needed.

The present invention, for example, can also be expressed as an invention of a computer program for controlling a management apparatus as follows.

### Expression 1.

A computer program for causing a computer, which manages a hierarchical storage system for hierarchically managing a file in a first file management apparatus and a second file management apparatus, to function as a management apparatus, the computer program respectively realizing on the above-mentioned computer: a replication processing part for creating a replica of a prescribed file, which is in the above-mentioned first file management apparatus, in the above-mentioned second file management apparatus; a duplicate removal processing part for removing duplicate data by selecting another prescribed file in the above-mentioned first file management apparatus in accordance with a preconfigured first prescribed condition as a duplicate data removal target, and converting the above-mentioned other prescribed file, which was selected, to a reference-source file, which references the data of a prescribed reference file; and a stubification processing part, which selects in accordance with a preconfigured second prescribed condition a stubification candidate file constituting a target of a stubification process for deleting data of the above-mentioned prescribed file in the above-mentioned first file management apparatus, and, in addition, leaving data only in the replica of the above-mentioned prescribed file created in the above-mentioned second file management apparatus, and, in addition, executing the above-mentioned stubification process with respect to the above-mentioned stubification candidate file in accordance with a preconfigured third prescribed condition.

### Expression 2.

A computer program according to Expression 1, further comprising a file access receiving part, which, in a case where the replica of a copy-source file in the above-mentioned first file management apparatus has been requested, creates the above-mentioned copy-source file replica as the above-mentioned reference-source file.

### Expression 3.

A computer program according to either Expressions 1 or 2, wherein the above-mentioned first file management apparatus is configured as a file management apparatus, which a user terminal can access directly, and the above-mentioned second file management apparatus is configured as a file management apparatus, which the above-mentioned user terminal cannot access directly.

### Expression 4.

A computer program according to any of Expressions 1 through 3, wherein the above-mentioned first prescribed condition is that a file for which the last access date/time is older than a preconfigured prescribed time threshold be selected from among files inside the above-mentioned first file management apparatus as the above-mentioned other prescribed file.

### Expression 5.

A computer program according to any of Expressions 1 through 4, wherein the above-mentioned second prescribed condition is that the above-mentioned stubification candidate be selected in a case where a free capacity inside the above-mentioned first file management apparatus falls below a prescribed free capacity threshold.

### Expression 6.

A computer program according to any of Expressions 1 through 5, wherein the above-mentioned third prescribed condition is that a file be selected from among the above-mentioned stubification candidate files in order from the file with the oldest last access date/time until the above-mentioned free capacity becomes equal to or larger than the above-mentioned prescribed free capacity threshold.

### Expression 7.

A computer program according to any of Expressions 1 through 6, wherein the above-mentioned reference-source file stores an inode number of the above-mentioned prescribed reference file, and the above-mentioned prescribed reference file is associated with the above-mentioned reference-source file as a reference destination.

### Expression 8.

A computer program according to any of Expressions 1 through 7, wherein the above-mentioned prescribed reference file stores a number of references denoting a number of the above-mentioned reference-source files, which have the above-mentioned prescribed reference file as a reference destination, and every time the above-mentioned reference-source file is deleted or every time the above-mentioned stubification process is implemented for the above-mentioned reference-source file, the above-mentioned number of references is decremented, and the above-mentioned file access receiving part is able to delete the above-mentioned prescribed reference file when the above-mentioned number of references reached 0.

### Expression 9.

A computer program according to any of Expressions 1 through 8, wherein the above-mentioned prescribed reference file is not selected as the above-mentioned prescribed file, the above-mentioned reference-source file, which references the above-mentioned prescribed reference file, is selected as the above-mentioned prescribed file, and the above-mentioned prescribed reference file becomes a processing target of the above-mentioned replication processing part and the above-mentioned stubification processing part.

### Expression 10.

A computer program according to Expressions 9, wherein the above-mentioned reference-source file, which is selected as the above-mentioned prescribed file, is sent to the above-mentioned second file management apparatus in a state in which all data, which must be referenced from among the data of the above-mentioned prescribed reference file, is stored.

### Expression 11.

A computer program according to any of Expressions 1 through 10, wherein the above-mentioned prescribed reference file is managed in accordance with a subdirectory, which corresponds to the size of the above-mentioned prescribed reference file, from among multiple subdirectories, which exist under a prescribed directory disposed in the above-mentioned first file management apparatus, and which are prepared beforehand by file size ranking.

### REFERENCE SIGNS LIST

1 Edge-side file management apparatus
2 Core-side file management apparatus
3 Management apparatus
10 File storage apparatus
11 Host computer
13 RAID system
20 Archiving apparatus
21 RAID system

1. A management apparatus for managing a hierarchical storage system, which hierarchically manages a file by a first file management apparatus and a second file management apparatus, the hierarchical storage system management apparatus comprising:
a replication processing part for creating a replica of a prescribed file, which is in the first file management apparatus, in the second file management apparatus;
a duplicate removal processing part for removing duplicate data by selecting another prescribed file in the first file management apparatus in accordance with a preconfigured first prescribed condition as a duplicate data removal target, and converting the other prescribed file, which has been selected, to a reference-source file, which references the data of a prescribed reference file; and
a stubification processing part, which selects in accordance with a preconfigured second prescribed condition a stubification candidate file, which constitutes a target of a stubification process for deleting data of the prescribed file in the first file management apparatus, and, in addition, leaving data only in the replica of the prescribed file created in the second file management apparatus, and, in addition, executing the stubification process with respect to the stubification candidate file in accordance with a preconfigured third prescribed condition.

2. A hierarchical storage system management apparatus according to claim 1, further comprising a file access receiving part, which, in a case where creation of the replica of a copy-source file in the first file management apparatus has been requested, creates the copy-source file replica as the reference-source file.

3. A hierarchical storage system management apparatus according to claim 1, wherein
the first file management apparatus is configured as a file management apparatus, which a user terminal can access directly, and
the second file management apparatus is configured as a file management apparatus, which the user terminal cannot access directly.

4. A hierarchical storage system management apparatus according to claim 1, wherein
the first prescribed condition is that a file, for which the last access date/time is older than a preconfigured prescribed time threshold, is selected from among files in the first file management apparatus as the other prescribed file,
the second prescribed condition is that the stubification candidais be selected in a case where a free capacity inside the first management apparatus falls below a prescribed free capacity threshold, and
the third prescribed condition is that a file is selected from among the stubification candidate files in order from the file with the oldest last access date/time until the free capacity becomes equal to or larger than the prescribed free capacity threshold.

5. A hierarchical storage system management apparatus according to claim 1, wherein the reference-source file stores an inode number of the prescribed reference file, whereby the prescribed reference file is associated with the reference-source file as a reference destination.

6. A hierarchical storage system management apparatus according to claim 1, wherein
the prescribed reference file stores the number of references denoting the number of the reference-source files, which use the prescribed reference file as a reference destination,
every time the reference-source file is deleted or every time the stubification process is implemented for the reference-source file, the number of references is decremented, and
the file access receiving part is able to delete the prescribed reference file when the number of references reaches 0.

7. A hierarchical storage system management apparatus according to claim 1, wherein
the prescribed reference file is not selected as the prescribed file,
the reference-source file, which references the prescribed reference file, is selected as the prescribed file, and
this prescribed reference file becomes a processing target of the replication processing part and the stubification processing part.

8. A hierarchical storage system management apparatus according to claim 7, wherein the reference-source file, which is selected as the prescribed file, is sent to the second file management apparatus in a state in which all data, which have to be referenced from among the data of the prescribed reference file, is stored.

9. A hierarchical storage system management apparatus according to claim 1, wherein the prescribed reference file is managed by a subdirectory, which corresponds to a size of the prescribed reference file, from among multiple subdirectories, which exist under a prescribed directory disposed in the first file management apparatus, and which are prepared beforehand by file size ranking.

10. A hierarchical storage system management apparatus according to claim 2, wherein
the file access receiving part
creates a new prescribed reference file, which constitutes the copy-source file reference destination in a case where the copy-source file is not the reference-source file,
associates the copy-source file with the newly created prescribed reference file and converts the copy-source file to a reference source file, which references the newly created prescribed reference file, and
creates a replicated file of the copy-source file as a reference-source file, which references the new the prescribed reference file by copying inode information of the copy-source file, which has been converted to the reference-source file, and associating the inode information with the replicated file.

11. A hierarchical storage system management apparatus according to claim 1, wherein
the stubification processing part
selects as a first stubification candidate file an unprocessed file, for which the time/date is older than a preconfigured other prescribed time threshold, and, in addition, for which the processing by the duplicate removal processing part has not been implemented, in a case where free capacity in the first file management apparatus has fallen below the prescribed free capacity threshold;
executes the stubification processing for the selected first stubification candidate file;
determines whether the free capacity is equal to or larger than the prescribed free capacity threshold;
ends the stubification processing in a case where the free capacity is equal to or larger than the prescribed free capacity threshold; and
in a case where the free capacity is not equal to or larger than the prescribed free capacity threshold, selects as a second stubification candidate file a reference-source file for which the period since having been converted to the reference-source file by the duplicate removal processing part is the shortest, and executes the stubification processing until the free capacity becomes equal to or larger than the prescribed free capacity threshold.

12. A hierarchical storage system management apparatus according to claim 1, wherein both the prescribed reference file and the reference-source file are selected as the prescribed file, and this prescribed file becomes a processing target of the replication processing part and the stubification processing part.

13. A hierarchical storage system management apparatus according to claim 12, wherein the last access date/time of the prescribed reference file is estimated based on the last access date/time of the reference-source file, which has the prescribed reference file as a reference destination.

14. A hierarchical storage system management apparatus according to claim 13, wherein the last access date/time of the prescribed reference file is calculated as an average value of the last access dates/times of multiple reference-source files, which have the prescribed reference file as a reference destination.

15. A method for managing in use of a management apparatus a hierarchical storage system, which hierarchically manages a file by a first file management apparatus and a second file management apparatus,
the method comprising the steps of, by means of the management apparatus:
creating a replica of a prescribed file, which is in the first file management apparatus, in the second file management apparatus;
selecting another prescribed file in the first file management apparatus in accordance with a preconfigured first prescribed condition as a duplicate data removal target;
removing duplicate data by converting the selected other prescribed file to a reference-source file, which references data of a prescribed reference file;
selecting in accordance with a preconfigured second prescribed condition a stubification candidate file, which constitutes a target of a stubification process for deleting data of the prescribed file in the first file management apparatus, and, in addition, leaving data only in the replica of the prescribed file created in the second file management apparatus; and
executing the stubification process for the stubification candidate file in accordance with a preconfigured third prescribed condition.
